(19) United States
(12) Patent Application Publication
(10) Pub. No.: US 2004/0085266 A1
(43) Pub. Date: May 6, 2004

(54) Method of forming ceramic capillary rib, ceramic paste used therefor, and apparatus for forming same

(75) Inventors: Yoshirou Kuromitsu, Omiya-shi (JP); Makoto Toriumi, Omiya-shi (JP); Yoshio Kanda, Omiya-shi (JP); Seiji Toyoda, Omiya-shi (JP); Hiroki Hirata, Omiya-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: MITSUBISHI MATERIALS CORPORATION, Tokyo (JP)

(21) Appl. No.: 10/694,902

(22) Filed: Oct. 29, 2003

Related U.S. Application Data
(62) Division of application No. 09/240,858, filed on Feb. 1, 1999.

(30) Foreign Application Priority Data
Jan. 30, 1998 (JP) 10-018894
Jul. 17, 1998 (JP) 10-203255
Nov. 6, 1998 (JP) 10-316013
Nov. 6, 1998 (JP) 10-316014
Dec. 21, 1998 (JP) 10-363182
Dec. 21, 1998 (JP) 10-363184
Dec. 21, 1998 (JP) 10-363185
Dec. 21, 1998 (JP) 10-363186

(51) Int. Cl. G09G 3/28; B29C 59/00

(52) U.S. Cl. 345/60; 264/139; 425/295

(57) ABSTRACT

A paste film is formed by coating a paste onto the surface of a substrate. In a state in which comb-teeth formed on at least a portion of the periphery of a blade is thrust into the paste film, the blade or the substrate is moved in a certain direction, thus forming ceramic capillary ribs on the substrate surface. The paste should preferably contain from 30 to 95 wt. % glass powder or mixed glass/ceramics powder, from 0.3 to 15 wt. % resin, and from 3 to 70 wt. % solvent mixture (a solvent. a plasticizer and a dispersant), and the ceramic ribs on the substrate should preferably have an aspect ratio of from 1.5 to 10. The blade should preferably have a pitch P, a gap w and a depth h as expressed by 0.03 mm≦h≦1.0 mm and w/P≦0.9, and ribs are foamable on an insulating layer by keeping the blade spaced apart from the substrate surface.

### BACKGROUND OF THE INVENTION

1. Field of the Invention

The present invention relates to a method of forming a ceramic capillary rib in a manufacturing process of FPDs (flat panel displays) such as a PDP (plasma display panel) and a PALC (plasma addressed liquid crystal display), a ceramic paste used in this method, and an apparatus for forming the same. More particularly, the invention relates to a blade used for forming a ceramic capillary rib, an AC-type PDP or PALC having a ceramic rib prepared from the capillary rib, and a manufacturing method thereof.

2. Description of the Related Art

A first of the conventional methods of forming ribs of this type comprises, as shown in FIG. 22, lap-coating a rib forming paste 2 containing glass powder a plurality of times on a glass substrate by conducting positioning with a prescribed pattern by the application of the thick-film printing process, drying and firing the same, and providing prescribed intervals between ribs on the substrate 1. The rib 8 has a height H usually within a range of from 100 to 300 μm, and a width W usually within a range of from 50 to 100 μm. A cell 9 between two ribs has a width usually within a range of from 100 to 300 μm.

A second of the conventional methods for forming a rib is known as the sand blasting method. This method comprises, as shown in FIG. 23, the steps of coating a ceramic paste containing glass powder onto the entire surface of a glass substrate 1 by the thick film process and then drying the same, or laminating a ceramic green tape containing glass powder, thereby forming a pattern forming layer 3 having a height of from 150 to 200 μm, covering the pattern forming layer 3 with a photosensitive film 4, further covering the film 4 with a mask 5, and conducting exposure and development, thereby forming a resist layer 6 of a prescribed pattern. Then, a portion serving as a cell 9 is removed by sand blasting from above the resist layer 6, and then the resist layer 6 is further eliminated by the use of a stripping agent to obtain desired ribs 8.

A PDP having such ribs can usually display characters and a graphic by arranging a plurality of fine discharge cells longitudinally and laterally (into a matrix shape) and causing the cells at necessary portions to emit light by discharging. The PDP is the object of active research and development efforts because of various advantages including a simple structure permitting easy scaling-up, a memory function, possibility of color display, and capability to form into a far larger screen with a smaller depth than a cathode ray tube used for television.

PDPs are classified into an AC-type which is one having an electrode structure in which a metal electrode is covered with a glass dielectric material, and a DC-type in which a metal electrode is exposed in a discharge space. For example, an AC-type PDP has a configuration, as shown in FIG. 24, in which a glass substrate 100 is covered with another glass substrate 103 via a plurality of ceramic ribs 102 formed at prescribed intervals on the glass substrate 100. A display electrode 103b covered with a protecting film 103a made of MgO (magnesium oxide) or the like and a dielectric layer 103c are formed on the surface of the glass substrate 103 opposite to the glass substrate 100. An address electrode 104a which is an anode discharge electrode and a fluorescent layer 104b are formed, respectively, in small spaces (hereinafter referred to as “discharge cells”) formed by partitioning by the glass substrate 100, the glass substrate 103 and the ribs 102. A discharge gas (not shown) is injected into the discharge cells 104. The PDP having the configuration as described above can display characters and a graphic by causing selective discharge light emission of the fluorescent layer 104b in the discharge cell 104 formed between the ribs 102 by impressing a voltage between the display electrode 103b and the address electrode 104a.

The aforementioned ceramic ribs 102 are formed, as shown in FIG. 25, on the glass substrate 100 by forming a plurality of rows of address electrodes 104a in a prescribed pattern on the glass substrate 100 (FIG. 25(a)), coating a ceramic paste by the screen printing process in a pattern other than that of the above-mentioned electrode 104a, and drying the same. These steps are repeated from ten to twenty times, and a plurality of ceramic green rib layers 105 thus laminated are formed between the plurality of rows of address electrodes 104a (FIG. 25(b). A plurality of ceramic ribs 102 having a height of from 100 to 200 μm are then formed by firing these ceramic green rib layers 105 (FIG. 25(c)).

In the first conventional forming method of ceramic ribs described above, shown in FIG. 22, the rib has a relatively small width W such as from 50 to 100 μm and the paste tends to drop after printing. It is therefore necessary to limit the thickness of the coated thick film in one run of coating to about 10 to 20 μm upon completion of firing. In this method, as a result, formation of a rib having a height FH of from 100 to 300 μm requires lap coating of the thick film many times such as from ten to twenty runs, and furthermore, the value of H/W obtained by driving the rib height H after lap-coating by the rib width W is as large as from 1.5 to 4, leading to a defect in terms of difficulty in forming ribs with a high degree of accuracy even by carrying out sufficient positioning upon printing the thick film.

The second conventional forming method is shown in FIG. 23, in which it is necessary to make a coating of a photosensitive film for forming the resist layer, and to carry out complicated step such as exposure and development. Another inconvenience is that removal of most part of the pattern forming layer by sand blast requires much material for the pattern forming layer.

Further, in the third conventional method for forming ceramic ribs as described above shown in FIG. 25, a drawback is that, when trying to reduce the rib width with a view to obtaining a PDP having pixels at a high density by increasing density of discharge cells, a sufficient strength of the ribs provided on the glass substrate is unavailable.

### SUMMARY OF THE INVENTION

A first object of the present invention is to provide a method of forming ceramic capillary ribs simply and accurately through a smaller number of steps without the waste of materials.

A second object of the invention is to provide a ceramic paste and a blade used for forming the aforementioned capillary ribs.

A third object of the invention is to provide an apparatus for forming the above-mentioned capillary ribs.

A fourth object of the invention is to provide a capillary rib formed by the aforementioned apparatus.

A fifth object of the invention is to provide a ceramic rib available by firing the above-mentioned ceramic capillary rib, the strength of which is not reduced even with a smaller width of the rib.

A sixth object of the invention is to provide an FPD having such ceramic ribs.

A first aspect of the invention, as shown in FIG. 1, relates to a method of forming ceramic capillary ribs 13, comprising the steps of: forming a ceramic paste film 11 by coating a ceramic paste on the surface of a substrate 10; and moving a blade 12 or the substrate 10 in a certain direction in a state in which comb-teeth 12b formed on at least a part of the blade 12 are thrust into the paste film 11, thereby forming a ceramic capillary rib 13 on the surface of the substrate 10.

By causing the blade 12 or the substrate 10 to move in a certain direction in a state in which the comb-teeth 12b is thrust into the paste film 11, the paste 11 at a portion of the film 11 formed on the substrate 10 surface corresponding to the comb-teeth 12b of the blade 10 moves into gaps between the comb-teeth 12b or is swept off. Only portions of the film 11 positioned in the gaps of the comb-teeth 12b remain on the substrate 10, and ceramic capillary ribs 13 are formed on the substrate 10 surface.

A second aspect of the invention, as shown in FIG. 7, relates to a method of forming ceramic capillary ribs 23, comprising the steps of: forming a ceramic paste film 11 by coating a ceramic paste on the surface of a substrate 10; and moving a blade 12 or the substrate 10 in a certain direction in a state in which comb-teeth 12b formed on at least a part of the blade 12 are thrust into the paste film 11, thereby forming a ceramic capillary layer 22 on the surface of the substrate 10 and ceramic capillary ribs 23 on the ceramic capillary layer 22.

By causing the blade 12 to move in a state in which the tips of the comb-teeth 12b are thrust into the paste film 11 so as to be spaced apart by a prescribed height from the substrate 10 surface, or by causing the substrate 10 to move in a certain direction, the paste up to the prescribed height from the substrate 10 surface remains on the substrate surface and forms a ceramic capillary layer 22. The portions of the paste above the ceramic capillary layer 22 corresponding to the comb-teeth 12b of the blade 12 move to gaps of the comb-teeth 12b or are swept off, and only paste located in the gaps of the comb-teeth 12b remains in the ceramic capillary layer 22, thus forming ceramic capillary ribs 23 on the ceramic capillary layer 22.

In the present specification, the term “ceramic paste” shall mean a paste comprising a glass powder or a mixed glass-ceramics powder, a resin, a solvent, a plasticizer, and a dispersant; the term “ceramic capillary” refers-to a state in which most of the resin, the solvent, the plasticizer and the dispersant remain after coating of the paste comprising the glass powder or the mixed glass-ceramics powder, the resin, the solvent, the plasticizer, and the dispersant; and the term “ceramic green” shall mean a state in which there remains almost no solvent while there remain the glass powder, the mixed glass-ceramics powder, the resin, the plasticizer and the dispersant.

### BRIEF DESCRIPTION OF THE DRAWINGS

Various other objects, features and attendant advantages of the present invention will be more fully appreciated as the same becomes better understood from the following detailed description when considered in connection with the accompanying drawings in which like reference characters designate like or corresponding parts throughout the several views and wherein:

FIG. 1 is a perspective view illustrating a forming state of ceramic capillary ribs in a first embodiment of the present invention;

FIG. 2 is a sectional view illustrating ceramic ribs obtained by drying, heating and firing the ceramic capillary ribs shown in FIG. 1 taken along line A-A;

FIG. 3 is a front view of a blade thereof;

FIG. 4 is a sectional view of FIG. 3 taken along line B-B;

FIG. 5 is a front view of another blade corresponding to FIG. 3;

FIG. 6 is a front view of still another blade corresponding to FIG. 3;

FIG. 7 is a perspective view, corresponding to FIG. 1, illustrating a forming state of the ribs with a ceramic capillary layer in a second embodiment of the invention;

FIG. 8 is a sectional view corresponding to FIG. 2 illustrating the ribs with the ceramic capillary layer obtained by drying, heating and firing the ribs with the ceramic capillary layer shown in FIG. 7 taken along line C-C;

FIG. 9 is a perspective view of a forming apparatus in the first embodiment of the invention;

FIG. 10 is a sectional view of FIG. 1 taken along line D-D illustrating a depressing means of the apparatus;

FIG. 11 is a side view illustrating a state of the blade moving on the substrate;

FIG. 12 is a sectional view of a substrate having ceramic capillary ribs formed on the upper surface thereof;

FIG. 13 is a sectional of a substrate having ceramic capillary ribs formed via a ceramic capillary layer formed on the upper surface thereof;

FIG. 14 is a perspective view of another forming apparatus in the first embodiment of the invention;

FIG. 15 is a perspective view of still another forming apparatus in the first embodiment of the invention;

FIG. 16 is a sectional view of FIG. 15 taken along line E-E illustrating a depressing means of the apparatus;

FIG. 17 is a side view illustrating a state in which movement of the substrate causes the blade to move on the substrate;

FIG. 18 is a perspective view of further another forming apparatus in the first embodiment of the invention;

FIG. 19 is a partially enlarged sectional view of a PDP in a third embodiment of the invention;

FIG. 20 is a sectional view illustrating ceramic ribs and an insulating layer obtained by drying, heating and firing ceramic capillary ribs and a capillary layer shown in FIG. 21 taken along line F-F;

FIG. 21 is a perspective illustrating a forming state of the ceramic capillary ribs and the capillary layer;

FIG. 22 is a sectional view illustrating formation of conventional ceramic ribs in sequence of steps;

FIG. 23 is a sectional view illustrating formation of another conventional ceramic ribs in sequence of steps;

FIG. 24 is a partially enlarged sectional view of a conventional PDP; and

FIG. 25 is a sectional view illustrating a conventional forming method of ceramic capillary ribs and a capillary layer.

### DESCRIPTION OF THE PREFERRED EMBODIMENTS

A first embodiment of the present invention will now be described in detail with reference to the drawings. The ceramic paste in this embodiment contains from 30 to 95 wt. % glass powder or mixed glass-ceramic powder, from 0.3 to 15 wt. % resin. and from 3 to 70 wt. % solvent medium containing a solvent, a plasticizer and a dispersant. The ceramic paste should preferably contain from 70 to 90 wt. % glass powder or mixed glass-ceramic powder, from 0.5 to 3.5 wt. % resin and from 7 to 20 wt. % solvent mixture (a solvent, a plasticizer and a dispersant). The content of the glass powder or the mixed glass-ceramic powder is limited within a range of from 30 to 95 wt. %. A content of under 30 wt. % makes it difficult to obtain ceramic capillary ribs of a prescribed shape by the use of a blade, and a content of over 95 wt. % makes it difficult to uniformly coat the paste on the substrate surface. The resin content is limited within a range of from 0.3 to 15 wt. %. A content under 0.3% makes it difficult to obtain ceramic capillary ribs of a prescribed shape by the use of the blade, and a content of over 15 wt. % makes it difficult to uniformly coat the paste on the substrate surface and leads to the drawback of organic substances remaining in the ceramic ribs after firing. Further, the content of the solvent mixture is limited within a range of from 3 to 70 wt. %. With a content of under 3 wt. %, it is difficult to uniformly coat the paste on the substrate surface, and with a content of over 70 wt. %. it is difficult to obtain ceramic capillary ribs of a desired shape by the use of the blade. By blending the paste as described above, it is possible to obtain a paste having a viscosity within a range of from 1,000 to 500,000 cps, and accurately form ceramic capillary ribs 13 while inhibiting dripping of the ceramic capillary ribs 13 formed on the substrate.

The glass powder must mainly comprise SiO₂, ZnO and PbO and have a softening point within a range of from 300 to 600° C. The mixed glass-ceramic powder contains a glass powder mainly comprising SiO, ZnO and PbO, and a ceramic powder serving as a filler such as alumina cordierite, mullite or forsterite. The ceramic powder is mixed with a view to achieving a thermal expansion coefficient of the formed ribs 13 equal to that of the glass substrate 10 and to improving the strength of the ceramic ribs after firing. The content of the ceramic powder should preferably be up to 60 vol. %. A content of the ceramic powder of over 60 vol. %, leading to porous ribs, is not desirable. The glass powder and the ceramic powder should preferably have a particle size within a range of from 0.1 to 30 μm, respectively. A particle size of the glass powder or the ceramic powder of under 0.1 μm tends to result in easier aggregation, thus leading to more difficult handling. A particle size of over 30 μm results in an inconvenience in or an impossibility of forming desired ribs 13 upon moving the blade as described later.

The resin must be a polymer which has a function of a binder, is easily pyrolyzable, and exhibits a high viscosity when dissolved in a solvent, such as ethylcellulose, acryl or polyvinylbutyral. The resin may be a thermosetting or photosetting resin, or may contain a thermosetting or photosetting resin. The resin may be, or may contain, a self-setting resin which polymerization-reacts with the solvent and increases paste viscosity with the lapse of time. Two or more kinds of thermosetting, photosetting and self-setting resins may be combined. Applicable combinations of a self-setting resin and a solvent polymerization-reacting therewith include, for example, a water soluble epoxy resin and triethylenetetramine, PVA and formaldehyde, and a non-water-soluble epoxy resin and xylenediamine. As a thermosetting resin, it is desirable to use one or more resins selected from the group consisting of phenol resins, urea resins, melamine resins, alkyd resins, silicone resins, furan resins, unsaturated polyester resins, epoxy resins and polyurethane resins. As a photosetting resin, it is desirable to use one or more reins selected from the group consisting of benzophenone resins, dibenzylketone resins, diethylthioxanthone resins, anthrone resins and dibenzosuberone resins.

The presence of a setting-type resins such as a thermosetting, photosetting or self-setting resin brings about the following two advantages. First, the viscosity of the paste to be coated is previously adjusted to a relatively low level suitable for coating, and after forming a paste film, the resin is caused to set so as to have a viscosity suitable for forming ceramic capillary ribs with the use of the blade. Secondly, the viscosity of the paste to be coated is previously adjusted to a relatively low-level suitable for coating, and after forming a paste film and forming ceramic capillary ribs by the blade, the resin is caused to set. This permits improvement of coating ability of the paste, and the prevention of dripping of the capillary ribs after formation of the capillary ribs.

(a) Setting of resin after forming the paste film: When a self-setting resin and a solvent polymerization-reacting therewith are added to the paste, paste having a viscosity of from 10,000 to 100,000 cps is coated to form a paste film 11, and then, the formed paste film 11 is held in the open air at the room temperature for 10 to 120 minutes. Polymerization-reaction of the self-setting resin and the solvent permits achievement of a hardness of the paste film suitable for forming capillary ribs even when the paste has a relatively low-viscosity.

When a thermosetting resin is contained in the paste, the paste having a viscosity of from 10,000 to 100,000 cps is coated to form a paste film 11, and then, the formed paste film is dried in the open air at a temperature of from 50 to 200° C. for 10 to 60 minutes. This causes the thermosetting resin serving as a binder to set, and the paste film has a hardness suitable for forming capillary ribs even when the paste has a relatively low viscosity.

When a photosetting resin is contained in the paste, the paste having a viscosity of from 10,000 to 100,000 cps is coated to form a paste film 11, and then immediately, ultraviolet rays having a prescribed wavelength (for example 256 nm) are irradiated for 0.5 to 10 minutes. As the photosetting resin serving as a binder sets at this point, the paste film has a hardness suitable for forming capillary ribs even when the paste has a relatively low viscosity.

After achieving a prescribed hardness of the paste film 11 through self-setting, thermosetting or photosetting as described above, capillary ribs 13 are formed by causing plastic deformation of the paste film 11 by the use of the blade 12. Because the paste film has a prescribed hardness, the ceramic capillary ribs 13 are formed with a high degree of accuracy by means of the blade 12 described below.

### (b) Setting of Resin After Forming Capillary Ribs

When causing the resin to set after forming ceramic capillary ribs, the thermosetting resin serving as a binder sets upon drying the ceramic capillary ribs, thus permitting prevention of deformation of ceramic green ribs after drying. When a photosetting resin is contained in the resin, the photosetting resin serving as a binder sets by irradiating ultraviolet rays onto the ceramic capillary ribs for a prescribed period of time, thus permitting prevention of deformation of the ceramic capillary ribs.

The solvent is an organic solvent having a relatively low volatility at the room temperature or water. Applicable organic solvents include alcoholic, ether and aromatic solvents. Among others, an alcoholic or ether solvent is preferable. Preferable alcoholic solvents include triethylene glycol and α-terepineol. Preferable ether solvents include diethylenether. When the resin contains a self-setting resin a solvent polymerization-reacting with this self-setting resin as described above should contained. A plurality of kinds of solvent having boiling points which differ by more than 30° C. may be used. Among the plurality of solvents, the one in with largest amount of blending should preferably have a blending ratio of up to 80 wt. %, or more preferably, up to 60 wt. %. The one with the smallest blended amount should preferably be blended at a ratio of at least 10 wt. %, or more preferably, at least 30 wt. %. These solvents become sequentially volatile upon drying after formation of the capillary ribs. These solvents include, for example, methoxyethylacetate and 2-ethoxyethanol for a boiling point of about 150° C., α-terepineol for a boiling point of about 200° C. and tetraethylene glycol, 135-pentadiol for a boiling point of at least 300° C. These solvents should appropriately be combined. When using a plurality of kinds of solvent having boiling points which differ by more than 30° C., the solvents do not volatilize during drying, and ceramic green ribs can be formed while keeping a satisfactory shape of the capillary ribs 13 as compared with the use of a single kind of solvent.

Applicable plasticizers include glycerine and dibutylphthalate, and applicable dispersants include benzene and sulfonic acid. A paste having a prescribed viscosity is available by using a paste having the composition as described above, and ceramic ribs can be formed at a high accuracy by conducting firing while inhibiting dripping of the ceramic capillary rib 13 formed on the substrate 10.

The solvent mixture may contain a degassing agent in addition to the solvent, the plasticizer and the dispersant. By adding a degassing agent to the solvent mixture, it is possible to remove foams from the paste film before forming the capillary ribs and eliminate pores in the ribs and small recesses on the plastic surface after formation of the capillary ribs. A degassing agent is known also as a defoamer. Applicable defoamers include silicone oil, sorbitan fatty acid ester, and polyoxyalkylenealkylether.

By using the blending as described above of the paste, there is available a paste having a viscosity of from 1,000 to 500,000 cps: the ceramic capillary ribs are accurately formed while inhibiting dripping of the ceramic capillary ribs formed on the substrate 10. When a setting resin is not contained, the paste should preferably have a viscosity of from 5,000 to 500,000 cps, or more preferably, from 10,000 to 300,000 cps. When a setting resin is contained, the viscosity should preferably be within a range of from 5,000 to 300,000 cps, or more preferably, from 10,000 to 100,000 cps.

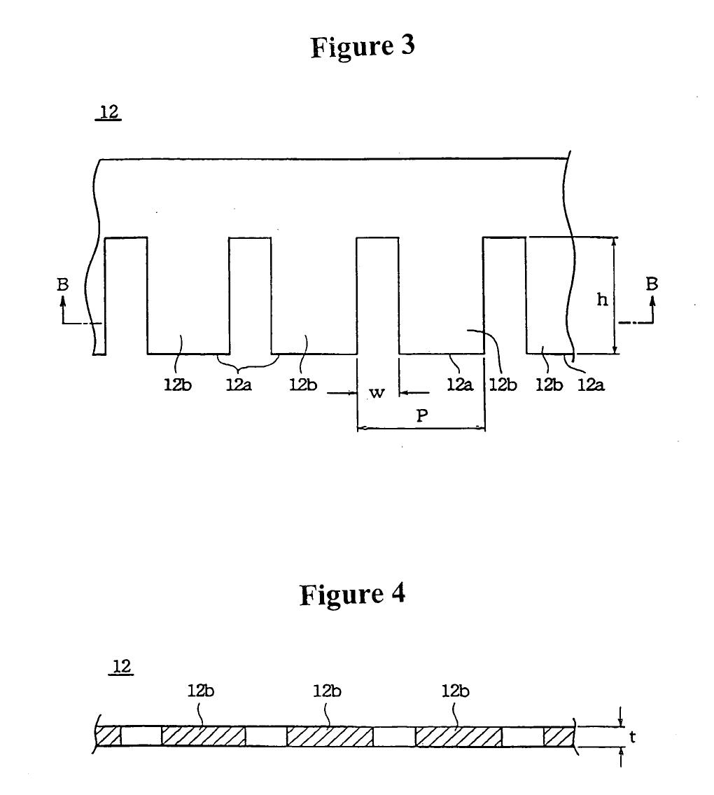

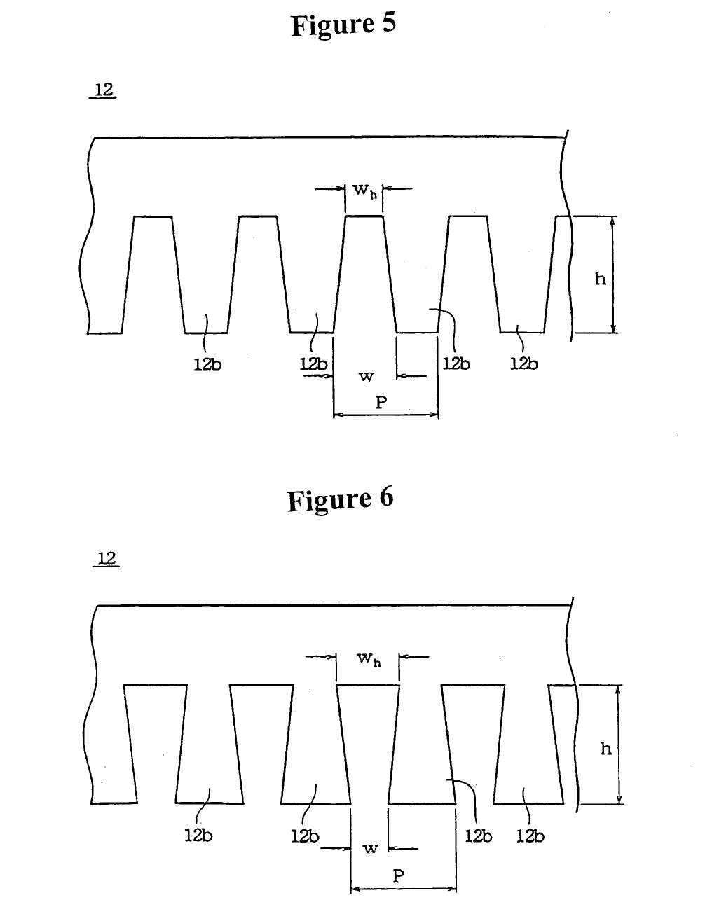

Coating of the paste onto the substrate 10 is carried out by conventional means such as a roller coating process, a screen printing process, a dripping process and a doctor blade process. When a defoamer is contained therein, a paste film 11 is formed on the substrate 10, and then, after forming the paste film 11 on the substrate 10, foams are excluded from the paste film 11 under the action of the defoamer in about one hour. When a defoamer is not contained therein, the paste film 11 should preferably be held for three to six hours after formation thereof to increase viscosity of the paste film to a prescribed level. A plurality of comb-teeth 12b are formed at equal intervals in a direction on a blade 12 to be brought into contact with the substrate 10 surface having the paste film 11 formed thereon. The blade 12 is made of a metal, a ceramic or a plastic which does not react with the paste or is never dissolved in the paste. Particularly from the point of view of size accuracy and durability, the material should preferably be a ceramic or an Fe, Ni or Co-based alloy. The gaps between the individual comb-teeth 12b are formed in response to the sectional shape of the ceramic capillary ribs 13 formed by the blade. As shown in FIGS. 3 and 4, the blade 12 has a thickness t within a range of from 0.01 to 3.0 mm. When the comb-teeth 12b has a pitch P, a gap W between teeth, and the gap has a depth h, it is desirable that 0.03 mm≦h≦1.0 mm, W/P≦0.9 and that the pitch P of the comb-teeth is at least 50 μm. The ceramic capillary ribs 13 formed by the blade 12 satisfying these conditions stiffen upon subsequent drying and firing, and dense ceramic ribs having desired rib gaps are thus available.

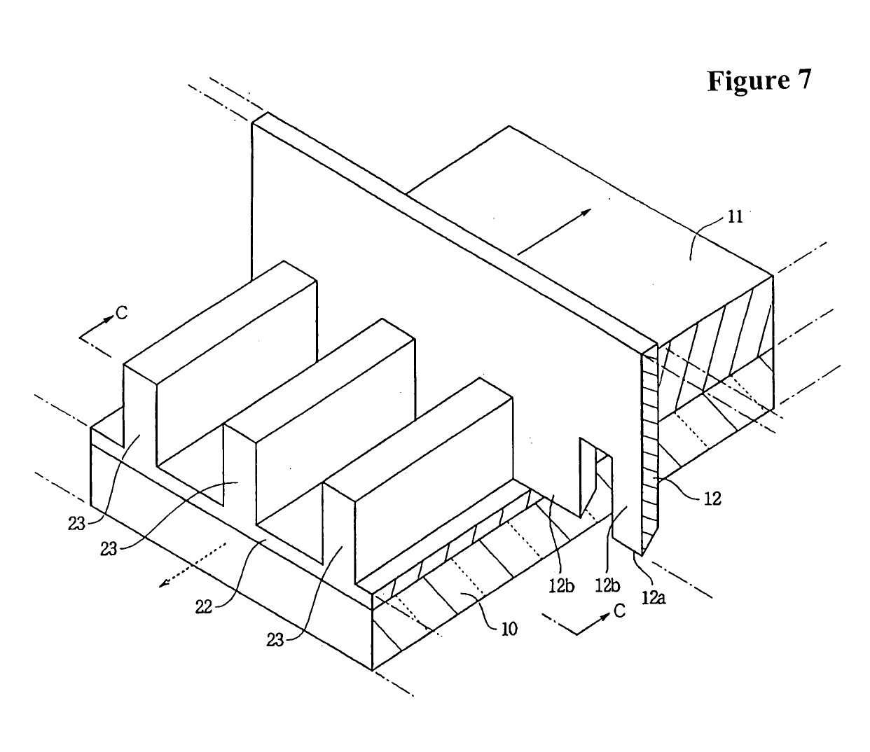

The shape of the gap between the comb-teeth 12b, apart from the rectangular shape as shown in FIG. 3, may be trapezoidal as shown in FIG. 5, or may be an inverted-trapezoidal shape as shown in FIG. 6, depending upon the use of the FPD finally prepared. When the trapezoidal gap between the comb-teeth 12b is adopted, it is possible to form ceramic capillary ribs 13 suitable for uses requiring a wider opening. An inverted-trapezoidal gap of the comb-teeth permits formation of ceramic capillary ribs 13 having side flattened top.

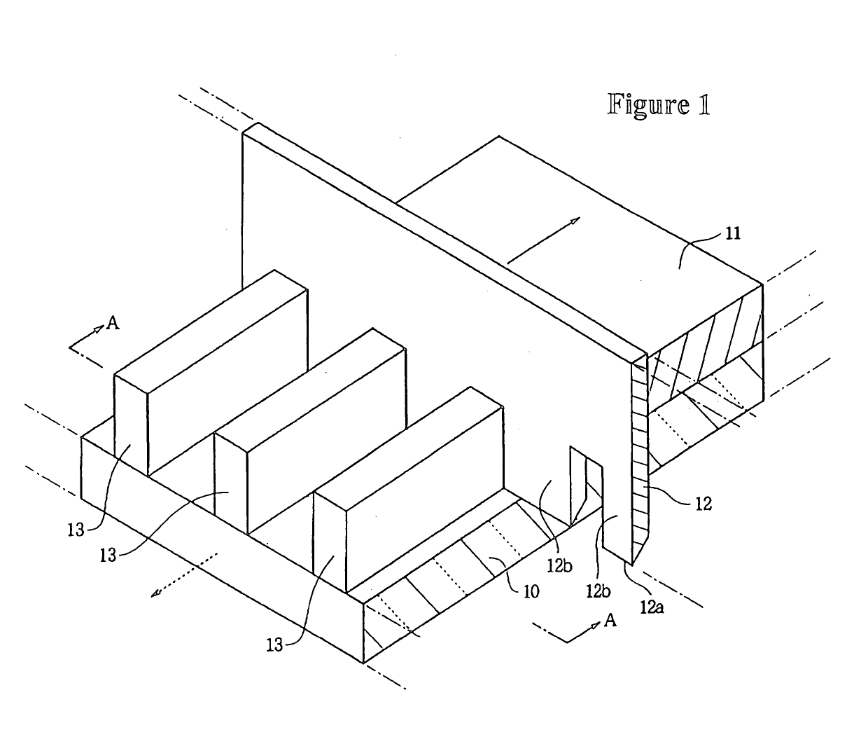

Referring again to FIG. 1, formation of the ceramic capillary ribs 13 by the use of the blade 12 having the configuration described above is accomplished by thrusting the comb-teeth 12b formed on the blade 12 into the ceramic paste film 11 formed by coating the ceramic paste onto the surface of the substrate 10, and with the edge 12a of the blade kept in contact with the substrate 10 surface, moving the blade in a certain direction as shown by the solid line arrow in FIG. 1 while fixing the substrate 10, or moving the substrate 10 in a certain direction as shown by the broken line arrow in FIG. 1 while fixing the blade 12. As a result of this movement, portions of the paste coated onto the substrate 10 surface, corresponding to the comb-teeth 12b of the blade 12 move to the gaps between the comb-teeth 12b or are swept off. Only the paste located in the gaps between the comb-teeth remains on the substrate 10, thus forming ceramic capillary ribs 13 on the substrate 10 surface. When the depth of the comb-teeth is larger than the thickness of the paste film 11, the paste swept off upon movement of the blade 12 or the glass substrate 10 enters the groove, thus permitting formation of the ceramic capillary ribs 13 having a height larger than the thickness of the paste film 11.

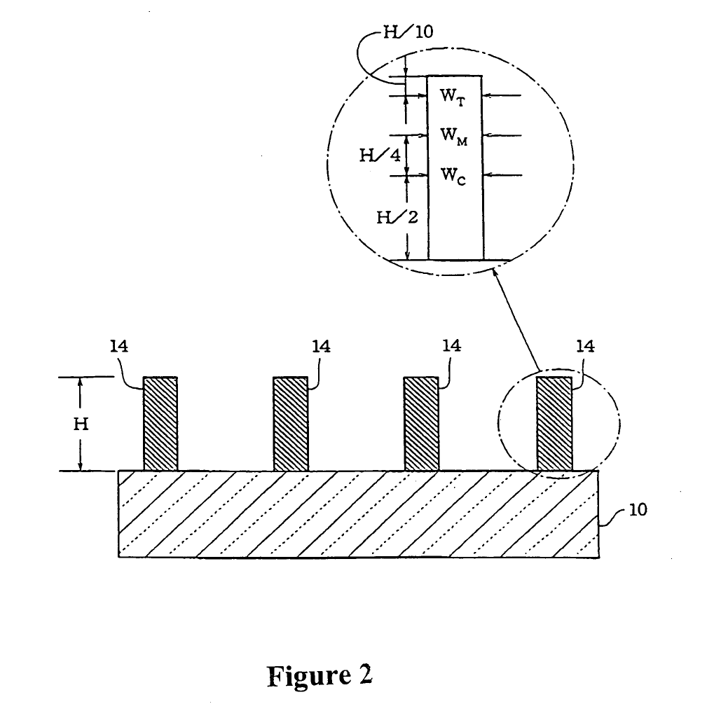

The thus formed ceramic capillary ribs 13 are then dried to become ceramic green ribs (not shown), and further heated for removing the binder, followed by firing, to form ceramic ribs 14 shown in FIG. 2. An FPD such as a PDP or a PALC (not shown) can be manufactured by the use of the thus formed ceramic ribs 14. When the ceramic ribs 14 formed on the substrate 10 are assumed to have a height H, a rib 14 width W_{c} of half (½) the height H, a rib 14 width W_{M} of ¾ths the height H, and a rib 14 width W_{T} at 9/10ths the height H, the dispersions of H, W_{c}, W_{M} and W_{T} expressed as (Maximum-Average)/Average should preferably be up to 5%, respectively, and the aspect ratio expressed as H/W, should preferably be within a range of from 1.5 to 10. An aspect ratio of from 1.5 to 10 permits very accurate formation of ceramic ribs 14.

A second embodiment of the invention will now be described in detail with reference to the drawings. The method of forming ceramic capillary ribs in this embodiment comprises, as shown in FIG. 7, the steps of coating a ceramic paste onto a substrate 10 to form a ceramic paste film 11, thrusting comb-teeth 12b formed on at least a part of the periphery of a blade 12 into the thus formed ceramic paste film, and moving the blade 12 or the substrate 10 in a certain direction with an edge 12a of the blade 12 spaced apart from the substrate 10 surface by a prescribed height, thereby forming a ceramic capillary layer 22 on the substrate 10 surface and ceramic capillary ribs 23 on this ceramic capillary layer 22. For the paste coating thereof being the same as in the above-mentioned first embodiment, description is omitted here.

More specifically, formation of the ceramic capillary ribs 23 by the use of the blade 12 is accomplished, as shown in FIG. 7, by fixing the substrate 10, with the edge 12a of the blade 12 spaced apart from the substrate 10 surface having the paste film 11 formed thereon by a prescribed height, and moving the blade 12 a certain direction as shown by the solid line arrow, or fixing the blade 12 and moving the substrate 10 in a certain direction as shown by the broken line arrow. As a result of this movement, the paste up to the prescribed height from the substrate 10 surface remains on the substrate surface to form the ceramic capillary layer 22. Portions of the paste present above the ceramic capillary layer 22 corresponding to the comb-teeth 12b of the blade move to the gap between the comb-teeth 12b or are swept off. Only the paste present in the gaps between the comb-teeth 12b remains on the ceramic capillary layer 22, whereby the ceramic capillary ribs 23 are formed on the ceramic capillary layer 22.

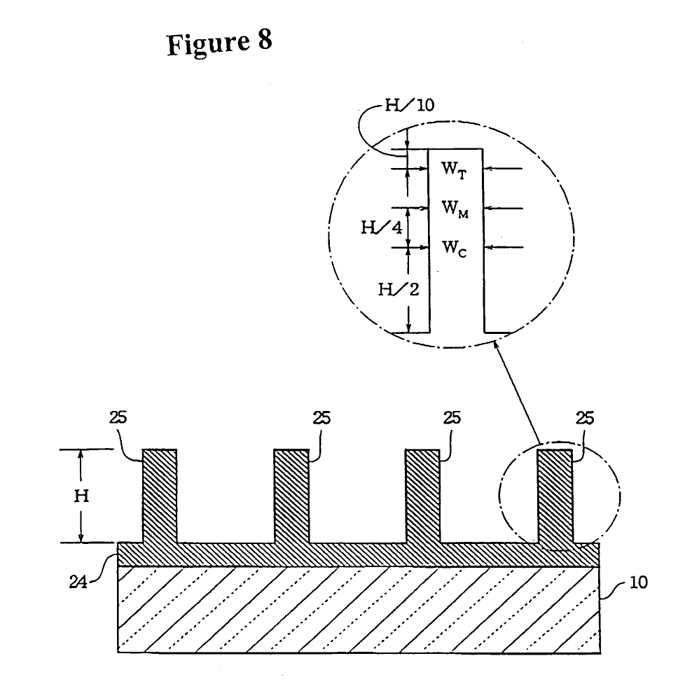

The ceramic capillary layer 22 and the ceramic capillary ribs 23 formed as described above are subsequently dried to form a ceramic green layer and ceramic green—ribs (not shown), and further heated for removing the binder. Through subsequent firing, an insulating layer 24 is formed on the substrate 10, and ceramic ribs 25 are formed on the insulating layer 24 as shown in FIG. 8. By the use of the ceramic ribs 25 formed on the insulating layer 24, it is possible to manufacture an FPD such as a PDP or a PALC (not shown). When the ceramic ribs 25 formed on the insulating layer 24 are assumed to have a rib 25 height H, a rib 25 width W_{c} of one-half the height H, a rib 25 width W_{M} at three-fourths the height H, and a rib 25 width W_{T} at six-tenths the height H, the dispersions of H, W_{c}, W_{M} and W_{T} expressed as (Maximum-Average)/Average should preferably be up to 5%, respectively, and the aspect ratio expressed as H/W_{c} should preferably be within a range of from 1.5 to 10. An aspect ratio of from 1.5 to 10 permits very accurate formation of ceramic ribs 25.

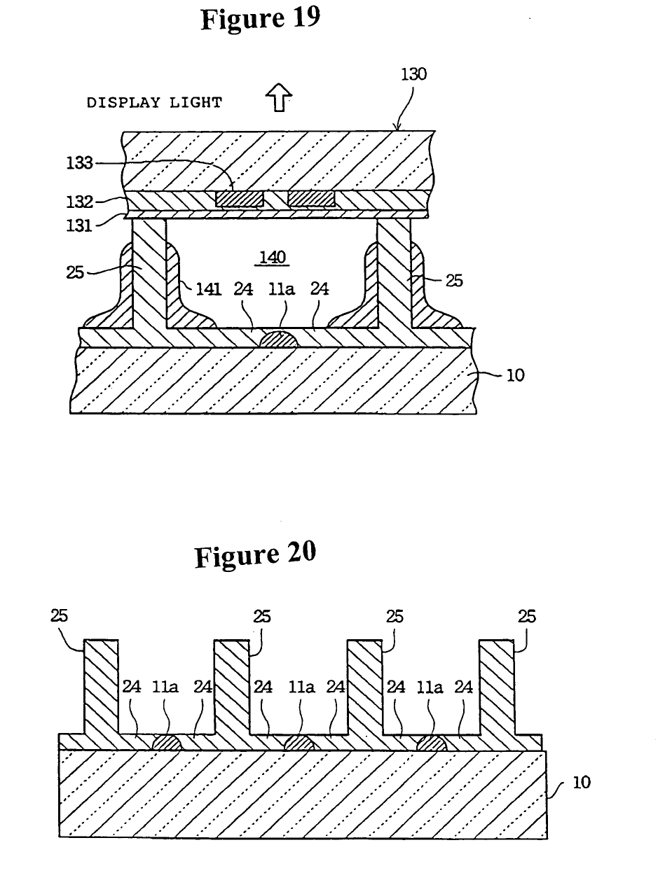

The manufacturing method of a PDP of a third embodiment of the invention will now be described. First, as shown in FIGS. 19 to 21, a plurality of rows of address electrodes 11a are formed with uniform heights at sites for forming electrodes on a substrate 10. A glass substrate which is an insulating substrate is suitable as a substrate in this embodiment. These electrodes 11a are formed on the substrate 10 by coating a conductive paste in a prescribed pattern, drying the coated paste in the open air atmosphere at 100 to 200° C. for 10 to 30 minutes, and then firing the dried paste at 560 to 600° C. for 5 to 30 minutes. It is recommendable to use an Ag conductive paste. In this embodiment, the address electrodes 11a have a uniform height within a range of from 10 to 20 μm. While the drawings show an address electrode 11a having a semicircular cross-section, an address electrode having a flat top surface may be adopted. Firing of the address electrodes may be carried out simultaneously with firing of ceramic capillary ribs and a ceramic capillary layer described later.

The same ceramic paste as described in the aforementioned first embodiment is coated onto the substrate 10 in the same manner as in the first embodiment to form a ceramic paste film 11 with a uniform thickness. Then, in the same manner as described in the second embodiment, ceramic capillary ribs 23 and a ceramic capillary layer 22 are formed from the paste film 11 on the substrate 10 surface by the use of a blade 12. The same blade 12 as in the above-mentioned first embodiment is used. For the purpose of forming the ceramic capillary layer 22 into a uniform thickness, edges 12a forming the tips of the plurality of comb-teeth 12b are aligned flat.

In this embodiment, as shown in FIGS. 3 and 4, the blade 12 is formed from a stainless steel sheet having a thickness t within a range of from 0.01 to 3.0 mm. The comb-teeth 12b has a pitch P within a range of from 50 to 1,000 μm, and the gaps between the comb-teeth 12b have a depth within a range of from 30 to 1,000 μm.

Formation of the ceramic capillary ribs 23 with the use of the blade 12 having the configuration described above is accomplished by fixing the substrate 10, with the edge 12a of the blade 12 brought into contact with the upper surfaces of the address electrodes 11a. and moving the blade 12 in a certain direction as shown by the solid line arrow in FIG. 21, or moving the substrate 10 in a certain direction as shown by the broken line arrow in FIG. 21 while fixing the blade 12. In this case, the ceramic capillary layer on the upper surfaces of the address electrodes 11a has a thickness of 0 μm. However, at least the base portions of the address electrodes 11a are covered with the ceramic capillary layer.

As a result of this movement, portions of the paste coated onto the substrate 10 surface corresponding to the comb-teeth 12b of the blade 12 move to the gaps of the comb-teeth 12b or are swept off, and only the paste present in the gaps of the comb-teeth 12b remains on the substrate 10. A plurality of ceramic capillary partitions 23 are thus formed on the substrate 10 surface between the plurality of rows of address electrodes 11a, and at the same time, the paste filling the space from the substrate 10 surface to the height of the address electrodes 11a remains on the substrate surface and forms a ceramic capillary layer 22. When the depth h of the grooves of the comb-teeth 12b is larger than the thickness of the paste film 11 the paste swept off upon movement of the blade 12 or the glass substrate 10 enters the groove, thus permitting forming ceramic capillary ribs 23 having a height larger than the thickness of the paste film 11.

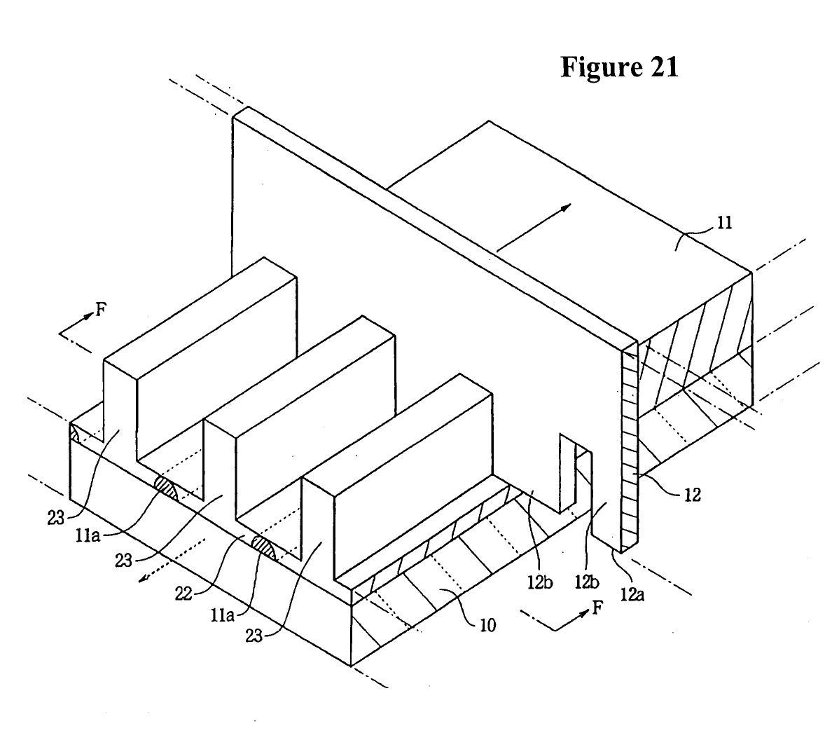

The ceramic capillary layer 22 and the ceramic capillary ribs 23 formed as described above become a ceramic green layer and ceramic green ribs (not shown) through subsequent drying causing volatilization of mainly the solvent, and further heated for separation of the organic binder from the resin. Subsequent firing permits simultaneous and integral formation of an insulating layer 24 and ceramic ribs 25 on the substrate 10 shown in FIG. 20.

In the embodiment described above, the blade 12 or the substrate 10, was moved while keeping the edge 12a in contact with the upper surface of the address electrode 11a. The ceramic capillary ribs 23 and the ceramic capillary layer 22 may be formed while keeping the blade 12 spaced apart from the substrate 10 surface by a prescribed height, without bringing the edge 12a into contact with the upper surface of the address electrodes 11a. The prescribed height is determined so as to achieve a thickness of the insulating layer 24 on the upper surface of the address electrodes 11a of up to 20 μm, or preferably, up to 10 μm. Providing the very thin insulating on the upper surface of the address electrodes 11a brings about an advantage of easier discharge. A thickness of over 20 μm is not desirable because this makes it difficult it difficult to impress a voltage between the address electrodes and the display electrode.

As shown in FIG. 19, another substrate 130 serving as a front glass is placed via the ceramic ribs 25 on the glass substrate 10. A display electrode 133 and a dielectric layer 132 covered with a protecting layer 131 made of MgO (magnesium oxide) or the like are formed on the surface of the glass substrate 130 opposite to the glass substrate 10. A discharge cell 140 is formed by the glass substrate 10, the glass substrate 130, and the ceramic ribs 25 having a fluorescent layer 141 on the surface thereof. A discharge gas is sealed in the discharge cell 140.

In the PDP having the above-mentioned configuration, characters and graphics can be displayed by selectively causing discharge light emission of the fluorescent layer 141 in the discharge cell 140 formed between ribs 25 by impressing a voltage between the display electrode 133 and the address electrodes 11a.

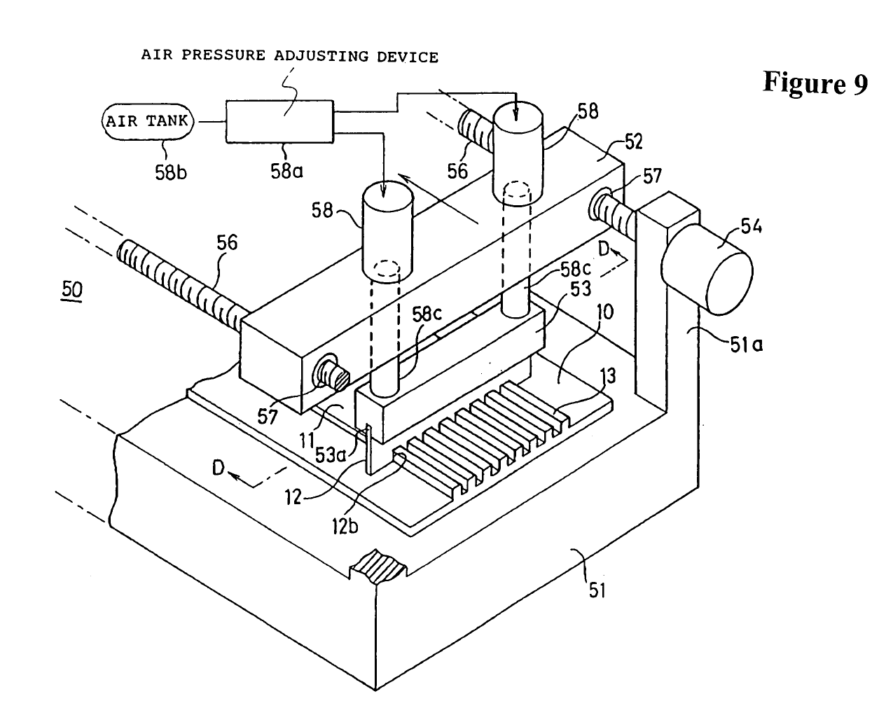

An apparatus for forming the ceramic capillary ribs of the first embodiment will now be described. As shown in FIG. 9, the apparatus 50 comprises a base 51 horizontally supporting the substrate 10, a moving head 52 horizontally movably provided above the base 51, a blade holder 53 holding the blade, attached to the moving head 52, and an actuator 54 causing horizontal movement of the moving head 52 together with the blade holder 53.

The base 51 has an upper surface formed horizontally, and a plurality of small holes communicating with a vacuum pump not shown are formed on the upper horizontal surface. The substrate 10 is arranged on the upper surface of the base 51 and has a configuration in which the substrate 10 comes into close contact with the upper surface of the base 51 by sucking air through the small holes. A plurality of pillars 51a (only one of the pillars being shown in the drawing) are provided at four corners of the upper surface of the base 51. A pair of male screw shafts 56 are horizontally provided on each pillar 51 a in parallel with each other. The moving head 52 is mounted on the pair of male screw shaft 56, and female screw bearings 57 engaging with the male screw shafts 56 are mounted on the both ends-where the male screw shafts 56 are inserted. The moving head 52 has a configuration in which the head 52 is horizontally movably above the base 51 along the male screw shafts 56 under the effect of rotation of the pair of male screw shafts 56.

The blade holder 53 is attached via holder depressing means 58, and the holder depressing means in this embodiment is an air cylinder 58 attached to the moving head 52. The blade 12 has comb-teeth 12b formed at the bottom thereof. The blade 12 is made of a metal, a ceramics, a plastics or the like which does not react with, or is not dissolved in, the paste. A slit 53a is formed in a direction perpendicular to the moving direction of the moving head 52 in the lower part of the blade holder 53. By inserting and fixing the upper portion of the blade 12 in this slit 53a, the blade 12 is held by the blade holder 53, with the lower part thereof having the comb-teeth 12b formed thereon kept horizontal opposite to the substrate 10, in a direction perpendicular to the moving direction of the moving head 52.

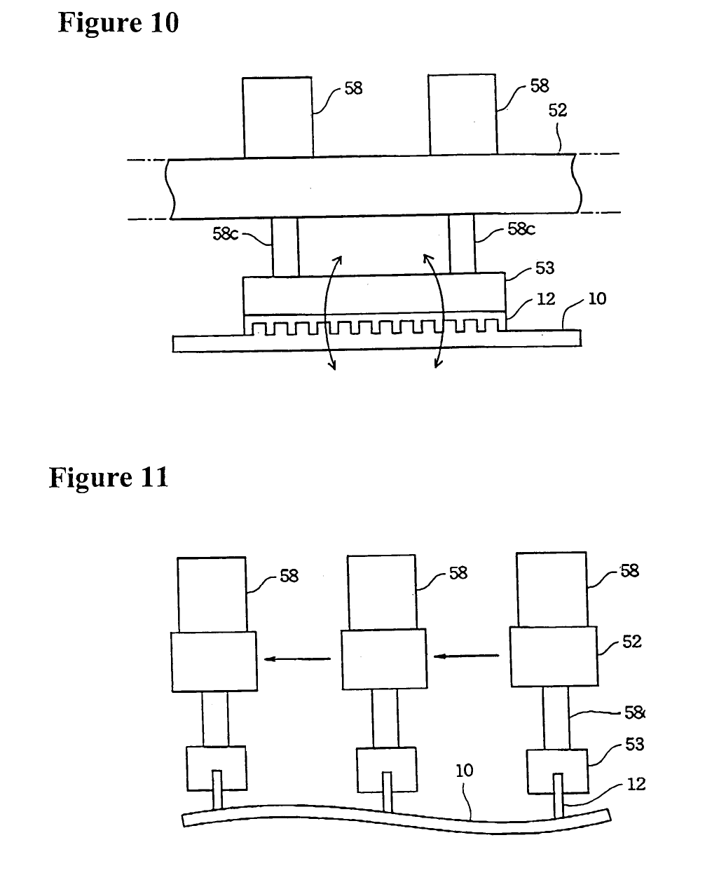

As shown in FIGS. 9 and 10, a pair of air cylinders 58 are provided on portions of the moving head 52 corresponding to both ends or corresponding to portions in proximity with both ends of the blade 12, and air tanks 58b are connected to the pair of air cylinders 58 via an air pressure adjusting apparatus 58a, respectively (FIG. 9). A rod 58c of each air cylinder 58 passes through the moving head 52 and projects downward, and the blade holder 53 is attached to the lower end of the rod 58c. When compressed air is supplied from the air tank 58b via the air pressure adjusting apparatus 58a, the air cylinder 58 pushes the rod 58c to project, and the rod 58c is withdrawn by discharging air form the air cylinder 58 by means of the air pressure adjusting apparatus 58a. In this configuration, along with projection or withdrawal of the rode 58c, the blade holder 53 moves up or down relative to the moving head 52, and the air cylinder 58 pushes out the rod 58c under a certain pressure by maintaining a constant air pressure in the air cylinder 58 through supply of compressed air in the air tank 58b by the air pressure adjusting apparatus 58a to the air cylinder 58, the lower end of the comb-teeth 12b being brought into contact with the substrate 10 as a result of depression of the blade 12.

Referring again to FIG. 9, a motor 54 (only one motor being shown) serving as an actuator for causing horizontal movement of the moving head 52 is provided on each of the pillars 51a on one side supporting one of the pair of male-screw shafts 56. The rotational shaft of this motor 54 is connected to the male-screw shaft 56, and the motor 54 is controlled by a motor driving circuit not shown. The motor 54 permits movement of the moving head 52 by causing rotation of the pair of male-screw shaft 56 in response to a signal from the motor driving circuit.

The forming procedure of the ceramic capillary ribs using the aforementioned forming apparatus of ceramic capillary ribs will now be described.

First, the paste is coated onto the substrate 10 to form a ceramic paste film 11 on the surface thereof. The substrate 10 having the thus formed ceramic paste film 11 is arranged on the upper surface of the base 51. The substrate 10 is brought into close contact with the upper surface of the base 51 by sucking air through a small hole of the base 51, thereby causing the base 51 to support the substrate 10. Then, compressed air is supplied to the air cylinder 58 to cause projection of the rod 58c and the blade holder 53 to descend. The comb-teeth 12b of the blade held by the blade holder 53 are thrust into the paste film 11 to bring the lower and of the comb-teeth 12b into contact with the substrate 10 under a certain pressure. In this state, the pair of male-screw shafts 56 are rotated by the motor 54 to move the movable head 52 in a direction shown by a solid line arrow in FIG. 9.

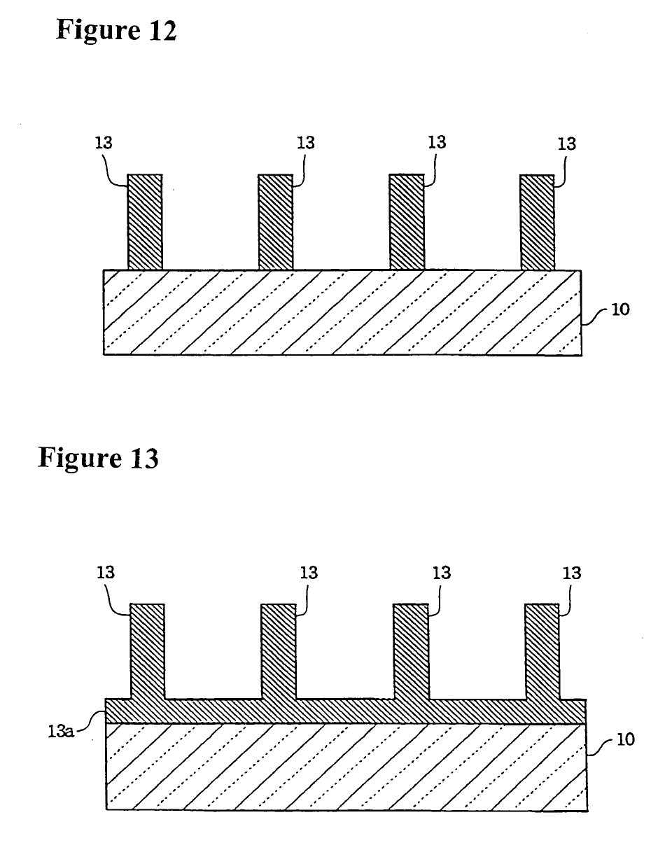

When the moving head 52 is moved, the blade holder 53 attached to the moving head 52 also moves with the blade 12. As a result of movement of the blade 12 in a certain direction, portions of the paste film 11 coated onto the substrate 10 surface corresponding to the comb-teeth 12b of the blade 12 move to the gaps between the comb-teeth 12b or swept off. Only the paste film 11 present in the gaps between the comb-teeth 12b remains on the substrate 10, and ceramic capillary ribs 13 are formed on the substrate 10 surface as shown in FIG. 12. When the depth of the groove of the comb-teeth 12b is larger than the thickness of the paste film, the paste swept off upon movement of the blade 12 enters the groove, and consequently, there are formed ceramic capillary ribs 13 having a height larger than the thickness of the paste film 11.

When the substrate 10 is curved, a force caused by the curvature is communicated to the lower end of the comb-teeth 12b in contact with the substrate 10 upon movement of the blade 12 in a certain direction. When the substrate 10 is curved in the moving direction of the blade as shown in FIG. 11, the rod 58c projects or is withdrawn, and the air cylinder 58 makes adjustment so that the lower end of the comb-teeth 12b comes into contact with the substrate 10 under a certain pressure. When the substrate 10 is curved in a direction perpendicular to the moving direction of the blade, rods 58c of the pair of air cylinders 58 provided at the both ends of the moving heads 52 project or are withdrawn by different amounts to cause the blade 12 to tilt as shown by the solid-line arrow in FIG. 10 in response to the extent of curvature, and adjustment is made so that the lower ends of the comb-teeth 12b are in contact with the substrate 10 under a certain pressure. As a result, ceramic capillary ribs 13 having uniform heights are formed on the substrate 10 surface as shown in FIG. 12 even when the substrate 10 is curved.

The thus formed ceramic capillary ribs 13 become ceramic green ribs through subsequent drying, although not shown, and further heated and dried to become ceramic-ribs.

Another apparatus of the first embodiment will now be described. The same reference numerals as those of the aforementioned apparatus represent the same parts, and repeated description thereof is omitted here.

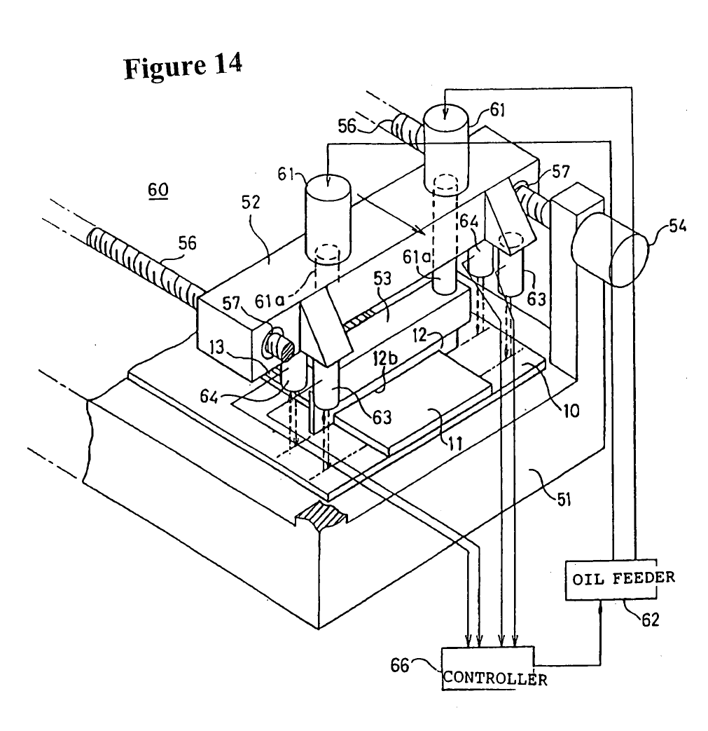

As shown in FIG. 14, this apparatus 60 comprises a base 51 horizontally supporting a substrate 10, a moving head 52 horizontally movably provided above the base 51, a blade holder 53 holding a blade 12, attached to the moving head 52, and a motor 54 serving as an actuator causing horizontal movement of the moving head 52 together with the blade holder 53. The blade holder 53 is vertically movably attached to the moving head 52 via blade adjusting means 61 adjusting the vertical position of the lower end of the comb-teeth 12b. The blade adjusting means in this embodiment is an oil cylinder 61 attached to the moving head 52.

A pair of oil cylinders 61 are attached to the moving head 52 at positions corresponding to both ends or positions in proximity with both ends of the blade 12. The pair of oil cylinders 61 are connected to oil feeders 62 incorporating oil tanks, respectively. The rod 61a of each oil cylinder 61 passes through the moving head 52 to project downward, and the blade holder 53 is attached to the lower end of the rod 61a. The blade holder 53 is vertically movably attached relative to the moving head 52 under the effect of projection or withdrawal of the rod 61a of the oil cylinder 61. The oil cylinder 61 causes projection or withdrawal of the rod 61a thereof to make the blade holder 53 vertically movable in response to the quantity of oil fed from the oil feeder 62.

The moving head 52 is provided with position sensors 63 and 64 for detecting a displacement of the substrate 10 surface from a reference position of the substrate surface. In this embodiment, the first position sensor 63 for detecting a displacement of the substrate 10 surface ahead in the moving direction shown by the two-point chain line of the blade 12 in FIG. 14, and the second position sensor 64 for detecting a displacement of the substrate 10 surface directly below in the longitudinal direction shown by a one-point chain line of the blade 12 in FIG. 14 are provided, respectively, on the both sides of the moving head 52 corresponding to the proximities to the both ends of the blade 12. The first and the second position sensors 63 and 64 emit a laser beam downward from the respective lower ends, and can detect a displacement of the substrate 10 surface relative to the reference position by detecting the laser reflected on the substrate 10 surface as shown by the broken line arrow. The term reference position of the substrate surface as herein used shall means the initial position of the substrate surface of the movement of the moving head 52 with the comb-teeth 12b thrust into the paste film 11. Detection output of the first and the second position sensors 63 and 64 is fed to a controller 36, and control output of the controller 36 is connected to the oil feeder 62. The controller 36 controls the oil cylinder 61, which is a blade adjusting means, via the oil feeder 62 in response to detection output of the position sensors 63 and 64.

In the forming apparatus 60 of ceramic capillary ribs having the configuration as described above, ceramic capillary ribs 13 are formed on the substrate 10 surface by moving the moving head 52 in the direction shown by the solid line arrow in FIG. 14, with the comb-teeth 12b of the blade 12 thrust into the paste film 11. Upon moving the blade 12, the controller 36 controls the oil cylinder 61 in response to the detection output of the position sensor 63 and 64. That is, the controller 36 vertically moves the blade holder 53 to match the displacement of the substrate surface relative to the initial position of the substrate surface of movement of the moving head 52 to make an adjustment so that the lower end of the comb-teeth 12b has a certain height from the surface of the substrate 10.

When the controller 66 makes an adjustment so as to bring the lower ends of the comb-teeth 12b into contact with the substrate 10, the ceramic capillary ribs 13 are formed on the surface of the substrate 10 as shown in FIG. 12. On the other hand, when the controller 66 makes an adjustment so as to keep the lower ends of the comb-teeth 12b spaced apart from the substrate 10 surface by a prescribed height, the paste film 11 ranging from the substrate 10 surface to the prescribed height remains on the surface of the substrate 10 and forms the ceramic capillary layer 13a there. The portion of the paste film 11 corresponding to the comb-teeth 12b of the blade 12 above the ceramic capillary layer 13a move to the gaps of the comb-teeth 12b or are swept off, and only the portions of the paste film 11 present in the gaps of the comb-teeth 12b remain on the ceramic capillary layer 13a, and as a result, the ceramic capillary ribs 13 are formed on the ceramic capillary layer 13a.

The relationship between the detection output of the position sensors 63 and 64 and the control of the oil cylinder 61 by the controller 66 is as follows. When the second position sensor 64 for detecting a displacement of the substrate 10 surface directly below in the longitudinal direction of the blade 12 (represented by the one-point chain line in FIG. 14) has a high sensitivity, the controller 66 immediately controls the oil cylinder 61 on the basis of the detection output to make an adjustment so as to keep the lower ends of the comb-teeth 12b spaced apart from the substrate 10 surface by a certain height. When the moving speed of the moving head 52 is relatively high, and control of the oil cylinder on the basis of the detection output of the second position sensor 64 would make it impossible to adjust the lower ends of the comb-teeth 12b at a certain height from the substrate 10 surface, the controller 66 previously calculates the amount of control in response to the detection output of the first position sensor 63 detecting a displacement of the substrate 10 surface ahead in the moving direction of the blade (represented by the two-point chain line), and at the point when the moving head 52 has moved by a prescribed amount, controls the oil cylinder 61 on the basis of the result of this calculation. An adjustment is thus made so as to keep the lower ends of the comb-teeth spaced apart from the substrate 10 surface by a certain height. In this case, the controller 66 confirms the extent of control of the oil cylinder 61 from the detection output of the second position sensor 64 detecting a displacement of the substrate 10 surface directly below in the longitudinal direction of the blade 12, and when there is a difference, it is possible to make a fine adjustment so as to keep the lower ends of the comb-teeth 12b at a certain height.

An adjustment may also be made by moving the moving head 52 without thrusting the comb-teeth 12b of the blade 12 into the paste film 11 while the substrate 10 is supported by the base 51, previously storing detection output detected by the position sensors 63 and 64 upon this movement in the controller 66, then, thrusting the comb-teeth 12b of the blade 12 into the paste film, and moving again the moving head 52, controlling the oil cylinder 61 by means of the controller 66 on the basis of-the stored detection output of the first and the second position sensors 63 and 64, thereby making an adjustment so as to keep the lower ends of the comb-teeth 12b spaced apart from the substrate 10 surface by a certain height.

When the substrate 10 is curved, the position sensors 63 and 64 detect a displacement of the substrate surface, and the controller 66 controls the oil cylinder 61 in response to the displacement of the substrate surface on the basis of the detection output to adjust the lower ends of the comb-teeth 12b at a certain height from the substrate 10 surface. As a result, it is possible to form ceramic capillary ribs 13 having a uniform height on the substrate 10 surface, or form ceramic capillary ribs 13 having a uniform height on the ceramic capillary layer 13a having a uniform thickness.

The ceramic capillary layer 13a and the ceramic capillary ribs 13 formed thereon shown in FIG. 13 are subsequently dried to become the ceramic green layer and the ceramic green ribs formed thereon, although not shown, and further heated for the removal of the binder, followed by firing to form an insulating layer and ceramic ribs formed thereon.

Still another apparatus of the first embodiment will now be described. In the drawings, the same reference numerals as in the aforementioned apparatus represent the same components, and description thereof is omitted here.

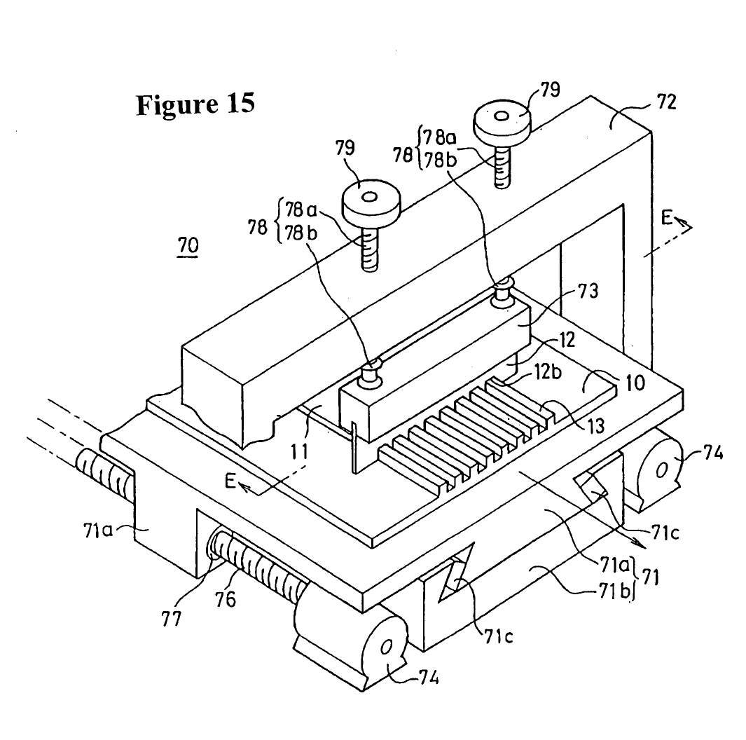

As shown in FIG. 15, the apparatus 70 comprises a base 71 horizontally supporting a substrate 10 and having a carriage 71 a for horizontally transferring the substrate 10, a fixed head 72 fixedly provided above the carriage 71a, a blade holder 73 attached to the fixed head 72 and holding a blade 12, and an actuator 74 for horizontally moving the carriage 71 a.

The base 71 has a base body 71b and the carriage 71a horizontally movably provided above the base body 71b via a bearing 71c. The upper surface of the carriage 71a is formed horizontal. Although not shown, a plurality of small holes communicating with a vacuum pump not shown are formed on the horizontal upper surface. The substrate 10 arranged on the upper surface of the carriage 71a can be supported on the upper surface of the carriage 71a by sucking air through these small holes. Expansions 71d are formed on the both sides of the carriage 71a with the base body 71b in between, and a pair male-screw shafts 76 (only one being shown) passing through the expansions 71d, respectively, are horizontally provided in parallel with each other on the both sides of the base body 71b. A female-screw bearing 77 screw-engaging with the male-screw shafts 76 is attached to each expansion 71d passed through by the male-screw shaft 76. The carriage 71a is horizontally movable above the base body 71b under the effect of rotation of the pair of male-screw shafts 76.

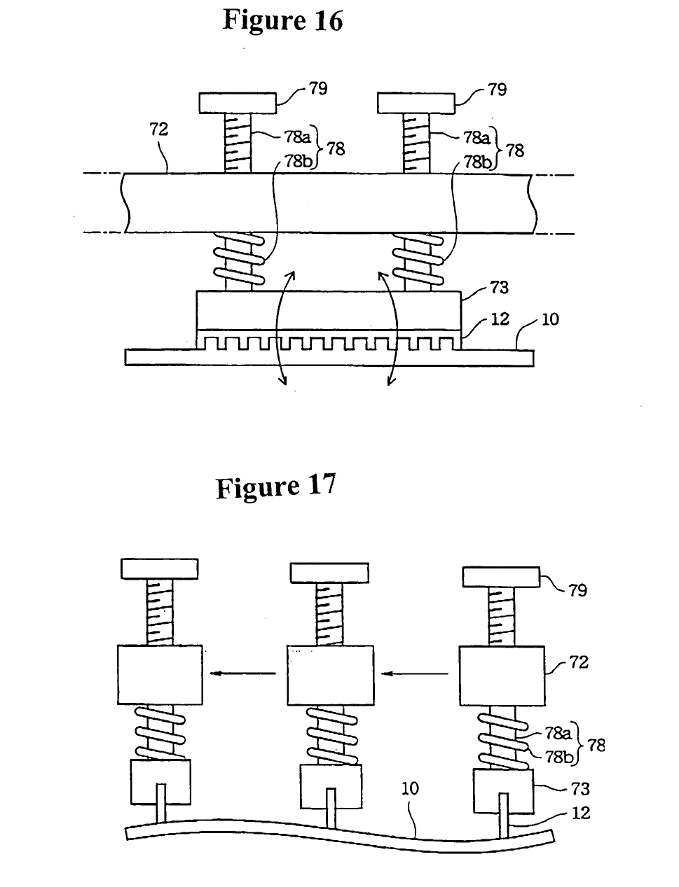

The blade holder 73 is attached via holder depressing means 78. The holder depressing means of this embodiment comprises a guide rod 78a provided vertically movably through the fixed head 72 and having a lower end secured to the top of the blade holder 73, and a spring 78b engaged with the guide rod 78a between the fixed head 72 and the blade holder 73. As shown in FIGS. 15 and 16, the holder depressing means 78 is provided at positions on the fixed head 72 corresponding to the both ends or proximities of the both ends of the blade 12. A male-screw is formed at the top of the guide rod 78a, and a nut is screw-engaged with the male screw. As a result of the vertical movement of the guide rod 78a relative to the fixed head 72, the blade holder 73 is vertically movably attached. The spring 78 engaged with the guide rod 78a depresses down the blade 12 held by the blade holder 73 with a certain pressure so as to bring the lower ends of the comb-teeth 12b into contact with the substrate 10 with a certain pressure.

Referring again to FIG. 15, motors 74 serving as actuators for rotating the pair of male-screw shafts 76 are provided on the both sides of the base body 71b, respectively. These motors 74 are controlled by a motor driving circuit not shown, and can move the carriage 71a by rotating the male-screw shafts 76.

In the forming apparatus 70 of ceramic capillary ribs having the configuration as described above, the substrate 10 having a ceramic paste film 11 formed by coated a paste onto the surface is arranged on the upper surface of the carriage 71a, and the substrate 10 is supported on the upper surface of the carriage 71a by bringing the substrate 10 into close contact there with, by sucking air through the small holes of the carriage 71a. Then, the nut screw-engaged with the top of the guide rod 78a is loosened to cause the blade holder 73 to descend. The comb-teeth 12b of the blade 12 held by the blade holder 73 are thrust into the paste film 11 so as to bring the lower ends of the comb-teeth 12b into contact with the substrate 10 under a certain pressure imparted by the spring 78b. In this state, the pair of male-screw shafts 76 are rotated by the motors 74 serving as actuators, thereby causing the carriage 71a to move in the solid-line direction in FIG. 15.

When the carriage 71a moves, the substrate 10 supported by the carriage 71a also moves together with the carriage 71a. As a result of movement of the substrate 10 in a certain direction, only the portions of the paste film 11 present in the gaps of the comb-teeth 12b on the substrate 10 surface remain on the substrate 10, thus forming ceramic capillary ribs 13 on the substrate 10 surface. As shown in FIG. 17, when the substrate 10 is curved in the moving direction of the carriage 71a, the guide rod 78a vertically moves in response to the curvature of the substrate 10, and the spring 78b makes an adjustment so as to bring the lower ends of the comb-teeth 12b into contact with the substrate 10 under a certain pressure. If the substrate 10 is curved in a direction perpendicular to the moving direction of the carriage 71a, the guide rods 78a vertically move in different manners to cause the blade 12 to tilt as shown by the solid-line arrow in FIG. 16 in response to the curvature. Adjustment is made so as to bring the lower ends of the comb-teeth 12b under a certain pressure, thus forming ceramic capillary ribs 13 having uniform heights on the substrate 10 surface.

Yet another apparatus of the first embodiment will now be described. In the drawings, the same reference numerals as in the aforementioned apparatus represent the same components, a description thereof is omitted here.

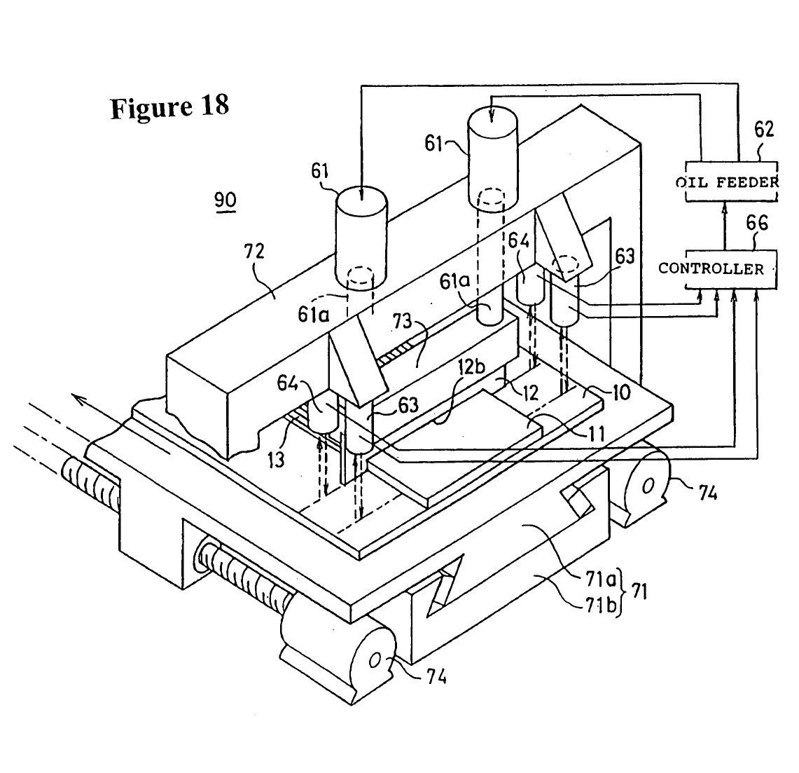

As shown in FIG. 18, the apparatus 90 comprises a base 71 having a carriage 71a horizontally supporting a substrate 10 and horizontally transferring the substrate 10, a fixed head 72 fixedly provided above the carriage 71a, a blade holder 73 attached to the fixed head 72 and holding a blade 12, and a motor 74 serving as an actuator horizontally moving the carriage 71a. The blade holder 73 is vertically movably attached to the fixed-head 72 via blade adjusting means 61 adjusting the vertical position of the lower ends of the comb-teeth 12b. The blade adjusting means in this embodiment is an oil cylinder 61 attached to the fixed head 72.

A pair of oil cylinders 61 are provided on fixed heads corresponding to the both ends or proximities to the both ends of the blade 12. The pair of oil cylinders 61 are connected to oil feeders 62, respectively. A rod 61a of each oil cylinder 61 passes through the fixed head 72 and projects downward. The blade holder 73 is attached to the lower end of the rod 61a. The blade holder 73 is vertically movably relative to the fixed head 72 as a result of projection or withdrawal of the rod 61a of the oil cylinder 61.

The fixed head 72 is provided with a first position sensor 63 for detecting a displacement of the substrate 10 surface ahead in the moving direction shown by the two-point chain line in FIG. 18 of the blade 12 when the moving carriage 71a is used as reference, and a second position sensor 64 for detecting a displacement of the substrate 10 surface directly below in the longitudinal direction shown by the one-point chain line in FIG. 18 of the blade. Detection output of the first and the second position sensors is connected to a controller 66, and control output of the controller 66 is connected to an oil feeder 62. The controller 66 controls the oil cylinder 61 serving as blade adjusting means via the oil feeder 62 form the detection output of the position sensors 63 and 64.

In the forming apparatus 90 of ceramic capillary ribs having the configuration as described above, ceramic capillary ribs 13 having uniform heights are formed on the substrate 10 surface, or ceramic capillary ribs 13 having uniform heights are formed on a ceramic capillary layer 13a having a uniform thickness, by thrusting the comb-teeth 12b of the blade 12 into the paste film 11, and moving the carriage 71a in the solid-line arrow direction in FIG. 18 together with the substrate 10. Since all the other points are the same as in the apparatus 60 described previously, a description thereof is omitted here.

In the four aforementioned apparatuses, the male-screw shaft and the female-screw bearing have been used as means for moving the moving head or the carriage. The moving means is not, however, limited to the above. For example, the moving head or the carriage may be movably supported by a simple supporting rod, and the moving head or the carriage may be horizontally moved along the supporting rod by fixing a part of a chain to the moving head or the carriage and moving the chain by a motor. The moving head or the carriage may be horizontally moved along the supporting rod together with the motor by forming a rack gear on the supporting rod, providing a motor having a rotation shaft provided with an outer gear engaging with the rack gear, and rotating the outer gear by the motor.

In the above-mentioned apparatus 50, the holder depressing means comprising an air cylinder 58 attached to the moving head 52 has been described, and in the apparatus 70, the holder depressing means comprising a guide rod 78a and a spring 78b has been described. The holder depressing means is not however limited to these, but may also be formed by using a hydraulic cylinder. In the aforementioned apparatuses 50 and 70, a pair of holder depressing means have been provided. A single holder depressing means may however be provided so far as it is possible to bring the lower ends of the comb-teeth into contact with the substrate under a certain pressure.

Further, the position sensor of detecting a displacement by detecting a reflected laser has been used in the aforementioned apparatuses 60 and 90, but the position sensor is not limited to this type. For example, a position sensor emitting an ultrasonic wave or infrared rays and detecting the reflected ultrasonic wave or infrared rays, thereby detecting a displacement thereof may be adopted, or the position sensor may detect a displacement of the substrate through detection of a probe kept in contact with the substrate surface. In this apparatus, a case where the position sensor detects a displacement of the substrate surface relative to a reference position has been presented. However, the position sensor may have a configuration of detecting a displacement of the surface of the ceramic paste film relative to a reference position of the ceramic paste film, so far as it is possible to coat the ceramic paste film with a uniform thickness on the substrate. Even when the controller make an adjustment so as to keep the lower ends of the comb-teeth with reference to a displacement of the ceramic paste film surface as detected by the position sensor, ceramic capillary ribs having uniform heights can be formed on the substrate surface, or ceramic capillary ribs can be formed on the ceramic capillary layer having a uniform thickness, so far as the ceramic paste film has a uniform thickness.

### EXAMPLES

Examples of the present invention will now be described in detail, together with comparative examples.

### Example 1

A PbO—SiO₂—B₂O₃ glass powder having an average particle size of 3 μm in an amount of 70 wt. % and an alumina powder having an average particle size of 5 μm in an amount of 30 wt. % serving as a filler were prepared, and sufficiently mixed. The resultant mixed powder, ethylcellulose serving as a resin, and a solvent mixture were blended at a ratio of 55/5/40 and sufficiently kneaded to obtain a paste. The solvent mixture was a mixture of α-terepineol serving as a solvent, glycerine serving as a plasticizer and sulfonic acid serving as a dispersant. A rectangular soda-line-based glass substrate 10 having a diagonal size of 40 inches an a thickness of 3 mm was fixed, and in this state, the paste was coated onto the glass substrate 10 by the screen printing process into a thickness of 200 μm, thereby forming a paste film 11.

On the other hand, a blade 12 was prepared from a stainless steel sheet having a thickness of 0.1 mm with comb-teeth having a pitch P of 100 μm, a gap. W between comb-teeth of 40 μm and a depth h thereof of 300 μm (FIG. 3). The comb-teeth 12b of this blade 12 were thrust into the paste film 11, and the substrate 10 was fixed in a state in which the edge 12a was brought into contact with the substrate 10 surface having the paste film formed thereon. A shown by the solid-line arrow in FIG. 1, the blade 12 was moved in a certain direction, thus forming ceramic capillary ribs 13 on the substrate 10 surface.

### Example 2

A ZnO—B₂O₃ glass powder having an average particle size of 2 μm, polyvinylbutylar serving as a resin, and a solvent mixture comprising diethylether (solvent), dibutylphthalate (plasticizer) and benzene (dispersant) were blended at a ratio of 60/10/30 and sufficiently kneaded to obtain a paste. The thus prepared paste was coated onto the same glass substrate 10 as in Example 1 by the screen printing process into a thickness of 100 μm to form a paste film. On the other hand, a blade 12 was prepared from a stainless steel sheet having a thickness of 0.1 mm with comb-teeth having a pitch P of 200 μm, a gap W between comb-teeth of 70 μm and a depth thereof of 300 μm (FIG. 3). The comb-teeth 12b of this blade 12 were thrust into the paste film 11, and the substrate 10 was fixed in a state in which the edge 12a was brought into contact with the substrate 10 surface having the paste film 11 formed thereon. As shown by the solid-line arrow in FIG. 1, the blade 12 was moved in a certain direction, thus forming ceramic capillary ribs 13 on the substrate 10 surface.

### Example 3

A PbO—ZnO—SiO₂ glass powder having an average particle size of 2.5 μm in an amount of 50 wt. % and an alumina powder having an average particle size of 3 μm in an amount of 50 wt. % serving as a filler were prepared and sufficiently mixed. The resultant mixed powder, polymethacrylate serving as a resin, and diethylether serving as a solvent were blended at a ratio of 30/15/55 and sufficiently kneaded to obtain a paste. The thus prepared paste was coated onto the same glass substrate 10 as in Example 1 by the screen printing process into a thickness of 200 μm to form a paste film. On the other hand, a blade 12 was prepared from a stainless steel sheet having a thickness of 0.1 mm with comb-teeth having a pitch P of 100 μm, a gap W between comb-teeth of 30 μm and a depth thereof of 300 μm (FIG. 3). The comb-teeth 12b were thrust into the paste film 11, and the substrate 10 was fixed in a state in which the edge 12a was brought into contact with the substrate 10 surface having the paste film 11 formed thereon. As shown by the solid-line arrow in FIG. 1, the blade 12 was moved in a certain direction, thus forming ceramic capillary ribs 13 on the substrate 10 surface.

### Example 4

A PbO—SiO₂—B₂O₃ glass powder having an average particle size of 3 μm in an amount of 80 wt. % and an alumina powder having an average particle size of 1 μm in an amount of 20 wt. % serving as a filler were prepared, and sufficiently mixed. The resultant mixture. an acrylic resin serving as a resin, and a solvent were blended at a ratio of 90/3/7 and sufficiently kneaded to obtain a paste. The solvent was diethylether alone. As shown in FIG. 7, the thus prepared paste was coated onto a soda-lime-based glass substrate 10 having a diagonal size of 40 inches and a thickness of 2 mm by the roller coating process into a thickness of 300 μm, thereby forming a paste film 11.

On the other hand, a blade 12 was prepared from an Ni sheet having a thickness of 0.05 mm with comb-teeth having a pitch P of 200 μm, a gap w between comb-teeth of 150 μm and a depth thereof of 200 μm (FIG. 3). The comb-teeth 12b of this blade 12 were thrust into the paste film 11, and the substrate 10 was fixed in a state in which the edge 12a was spaced apart from the substrate 10 surface by 20 μm. As shown by the solid-line arrow in FIG. 7, the blade 12 was moved in a certain direction, thus forming a ceramic capillary layer 22 on the substrate 10 surface and ceramic capillary ribs 23 on the ceramic capillary layer 22.

### Example 5

The same paste as in Example 3 was prepared and coated onto the same glass substrate 10 as in Example 1 by the screen printing process into a thickness of 200 μm, thereby forming a paste film. On the other hand, a blade 12 was prepared from a stainless steel sheet having a thickness of 0.1 mm with comb-teeth having a pitch P of 200 μm, a gap W between comb-teeth of 100 μm and depth thereof of 200 μm (FIG. 5). The comb-teeth 12b of this blade 12 were thrust into the paste film 11, and the substrate 10 was fixed in a state in which the edge 12a was brought into contact with the substrate 10 surface having the paste film 11 formed thereon. As shown by the solid-line arrow in FIG. 1, the blade 12 was moved in a certain direction, thus forming ceramic capillary ribs 13 on the substrate 10 surface.

### Example 6

The same paste as in Example 3 was prepared and coated onto the same glass substrate 10 as in Example 1 by the screen printing process into a thickness of 200 μm, thereby forming a paste film. On the other hand, a blade 12 was prepared from a stainless steel sheet having a thickness of 0.1 mm with comb-teeth having a pitch P of 200 μm, a gap W between comb-teeth of 150 μm and a depth thereof of 200 μm (FIG. 6). The comb-teeth 12b of this blade 12 were thrust into the paste film 11, and the substrate 10 was fixed in a state in which the edge 12a was brought into contact with the substrate 10 surface having the paste film 11 formed thereon. As shown by the solid-line arrow in FIG. 1, the blade 12 was moved in a certain direction, thus forming ceramic capillary ribs 13 on the substrate 10 surface.

### Example 7

A PbO—SiO₂—B₂O₃ glass powder having an average particle size of 2 μm in an amount of 80 wt. % and an alumina powder having an average particle size of 0.5 μm in an amount of 20 wt. % serving as a ceramic filler were prepared, and sufficiently mixed. The resultant mixed powder, a phenol resin (thermosetting resin), and ethyleneglycolether were blended at a ratio of 80/0.8/9.2 and sufficiently kneaded to obtain a paste. In a state in which the same glass substrate 10 as in Example 1 was fixed, the paste was coated onto the glass substrate 10 by the roller coating process into a thickness of 500 μm, thereby forming a paste film 11.

On the other hand, a blade 12 was prepared from a stainless steel sheet having a thickness t of 0.5 mm with comb-teeth having a pitch P of 500 μm, a gap w between comb-teeth of 100 μm and a depth h thereof of 500 μm (FIGS. 3 and 4). The comb-teeth 12b of this blade 12 were thrust into the paste film 11 while the glass substrate was fixed, and in a state in which the edge 12a was brought into contact with the glass substrate 10, the blade 12 was moved in a certain direction shown by solid-line arrow in FIG. 1, thus forming ceramic capillary ribs 13 on the substrate 10 surface through plastic deformation of the paste film 11.

### Example 8

A PbO—SiO₂—B₂O₃ glass powder having an average particle size of 1 μm in an amount of 80 wt. % and an alumina powder having an average particle size of 1 μm in an amount of 20 wt. % serving as a ceramic filler were prepared, and sufficiently mixed to prepare a mixed powder, on the other hand, 80 wt. % ethylcellulose and 20 wt. % epoxy resin (thermosetting resin) were prepared, and sufficiently mixed to prepare a mixed resin. The above mixed powder, the mixed resin and α-terepineol (solvent) were blended at a ratio of 70/10/20, and sufficiently kneaded, thereby obtaining a paste. A paste film was formed by coating the paste onto the same glass substrate as in Example 1 in the same manner as in Example 1. Ceramic capillary ribs 13 were formed on the substrate surface by thrusting the blade into this paste film, moving the same and causing plastic deformation of the paste film.

### Example 9

Ceramic capillary ribs were formed on the substrate surface in the same manner as in Example 8 except that water in the same amount was used in place of α-terepineol.

### Example 10

A PbO—SiO₂—B₂O₃ glass powder having an average particle size of 3 μm in an amount of 80 wt. % and an alumina powder having an average particle size of 1 μm in an amount of 20 wt. % serving as a ceramic filler were prepared and sufficiently mixed. The resultant mixed powder, a benzophenone resin (photosetting resin), and ethyleneglycoldiethylether (solvent) were blended in a weight ratio of 60/0.5/9.5, and sufficiently kneaded to obtain a paste. A paste film was formed by coating the paste on the same glass substrate as in Example 1 in the same manner as in Example 1. Ceramic capillary ribs 13 were formed on the substrate surface by thrusting the blade into the paste film, moving the same, and causing plastic deformation of the paste film. The above steps were carried out in an atmosphere prepared by shielding ultraviolet rays.

### Example 11

A PbO—SiO₂—B₂O₃ glass powder having an average particle size of 1 μm in an amount of 80 wt. % and an alumina powder having an average particle size of 0.5 μm in an amount of 20 wt. % serving as a ceramic filler were prepared. and sufficiently mixed. The resultant in mixed powder, a mixed resin of a water-soluble epoxy resin/triethylenetetramine and ethylcellulose serving as self-setting resin/solvent, and a solvent mixture were blended at a weight ratio of 75/1/24, and sufficiently kneaded to obtain a paste. The solvent mixture was prepared by mixing α-terepineol serving as a solvent, glycerine serving as a plasticizer, sulfonic acid serving as a dispersant and silicone oil serving as a defoamer. A paste film 11 was formed by coating the paste on the same glass substrate as in Example 1 while fixing the glass substrate by the screen printing process as shown in FIG. 1 into a thickness of 300 μm.

On the other hand, a blade 12 was prepared from a stainless steel sheet having a thickness t of 0.1 mm with comb-teeth having a pitch P of 300 μm, a gap w between comb-teeth of 150 μm and a depth h thereof 300 μm (FIGS. 3 and 4). After coating of the paste and holding of the paste film in the open air at the room temperature for an hour, ceramic capillary ribs 13 on the substrate 10 surface by thrusting the comb-teeth 12b of the blade 12 into the paste film while fixing the glass substrate, and in a state in which the edge 12a is brought into contact with the glass substrate 10, moving the blade 12 in a certain direction shown by the solid-line arrow in FIG. 1, thereby causing plastic deformation of the paste film 11.

### Example 12

A PbO—SiO₂—B₂O₃ glass powder having an average particle size of 0.5 μm in an amount of 80 wt. % and an alumina powder having an average particle size of 0.5 μm in an amount of 20 wt. % serving as a ceramic filler were prepared, and sufficiently mixed, thereby preparing a mixed powder, on the other hand, 80 wt. % phenol resin (thermosetting resin) and 20 wt. % ethylcellulose were sufficiently mixed, thereby preparing a mixed resin. The above mixed powder, the mixed resin and a solvent medium were blended at a weight ratio of 80/3/17, and sufficiently kneaded to obtain a paste, the solvent medium was prepared by mixing triethyleneglycol serving as a solvent and sorbitan fatty acid ester serving as a defoamer. A paste film was formed by coating this paste onto the same glass substrate as in Example 1 in the same manner as in Example 1. After holding the paste film in the open air at 80° C. for an hour, ceramic capillary ribs 13 were formed on the substrate surface by thrusting the blade into the paste film, moving the same, and causing plastic deformation of the paste film.

### Example 13

A PbO—SiO₂—B₂O₃ glass powder having an average particle size of 3 μm in an amount of 80 wt. % and an alumina powder having an average particle size of 1 μm in an amount of 20 wt. % serving as a ceramic filler were prepared. and sufficiently mixed. The resultant mixed powder, a benzophenone resin (photosetting resin), and a solvent medium were blended at a weight ratio of 90/0.5/9.5, and sufficiently kneaded to obtain a paste. The solvent medium was prepared by mixing α-terepineol serving as a solvent and polyoxyalkylene alkylether serving as a defoamer. A paste film was formed by coating this paste onto the same glass substrate as in Example 1 in the same manner as in Example 1. After irradiating ultraviolet rays having a wavelength of 256 nm, ceramic capillary ribs 13 were formed on the substrate surface by thrusting the blade into the paste film and causing plastic deformation of the paste film. Until formation of the paste film, the above steps were carried out in an atmosphere prepared by shielding ultraviolet rays.

### Example 14

A PbO—SiO₂—B₂O₃ glass powder having an average particle size of 0.8 μm in an amount of 80 wt. % and an alumina powder having an average particle size of 0.3 μm in an amount of 20 wt. % serving as a ceramic filler were prepared, and sufficiently mixed. The resultant mixed powder, ethylcellulose serving as a resin, and a solvent mixture were blended at a weight ratio of 80/0.5/19.5, and sufficiently kneaded to obtain a paste. The solvent mixture was prepared by mixing three solvents methoxyethylacetate, α-terepineol and tetraethyleneglycol at a weight ratio of 1/1/1. In a state in which the same glass substrate 10 as in Example 1 was fixed, the aforementioned paste was coated onto the glass substrate 10 by the roller coating process into a thickness of 250 μm, thereby forming a paste film 11.

On the other hand, a blade 12 was prepared from a stainless steel sheet having a thickness t of 0.7 mm with comb-teeth having a pitch P of 300 μm, a gap w between comb-teeth of 150 μm and a depth h thereof of 300 μm (FIGS. 3 and 4). After coating the paste and holding the paste film in the open air at the room temperature for three hours, ceramic capillary ribs 13 were formed, while fixing the glass substrate, by thrusting the comb-teeth 12b of the blade 12 into the paste film, and in a state in which the edge 12a in contact with the glass substrate 10, moving the blade 12 in a certain direction shown by the solid-line arrow in FIG. 1 to cause plastic deformation of the paste film 11.

### Example 15

A PbO—SiO₂—B₂O₃ glass powder having an average particle size of 2 μm in an amount of 50 wt.% and an alumina powder having an average particle size of 1 μm in an amount of 50 wt.% serving as a ceramic filler were sufficiently mixed to prepare a mixed powder. The resultant mixed powder, ethylcellulose serving as a resin and a solvent mixture were blended in a weight ratio of 75/1/24, and sufficiently kneaded, thereby obtaining a paste. The solvent mixture was prepared by mixing three solvents 2-ethoxyethanol, α-terepineol and 1.5-pentanediol at a weight ratio of 2/2/1. A paste film was formed by coating this paste onto the same glass substrate as described in Example 1 in the same manner as shown in Example 1. After holding the paste film in the open air at the room temperature for three hours, ceramic capillary ribs 13 were formed on the substrate surface by thrusting the blade into the paste film, and moving the blade to cause plastic deformation of the paste film.

### Comparative Example 1

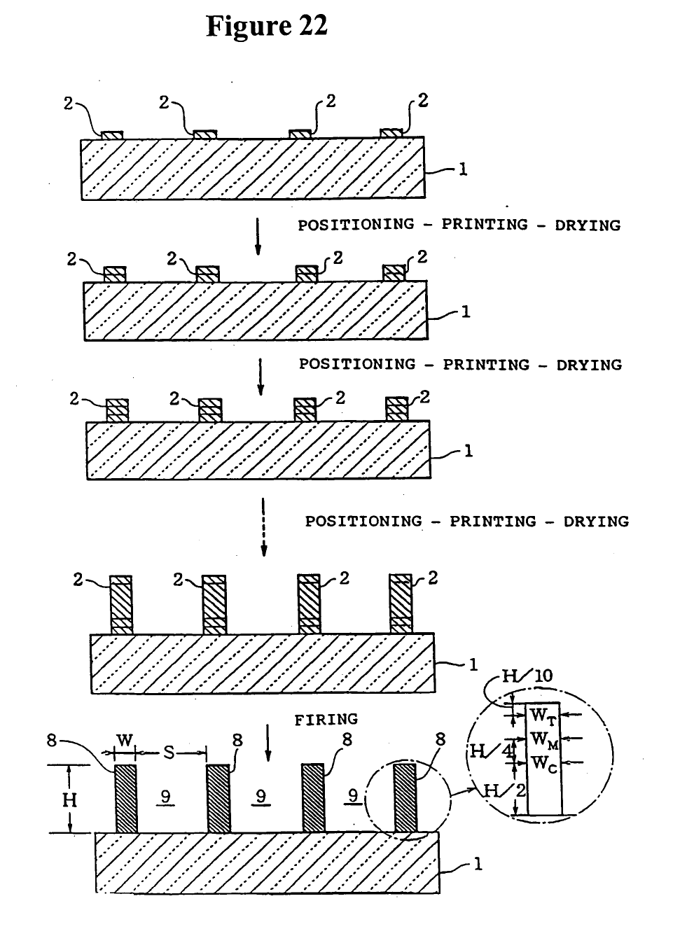

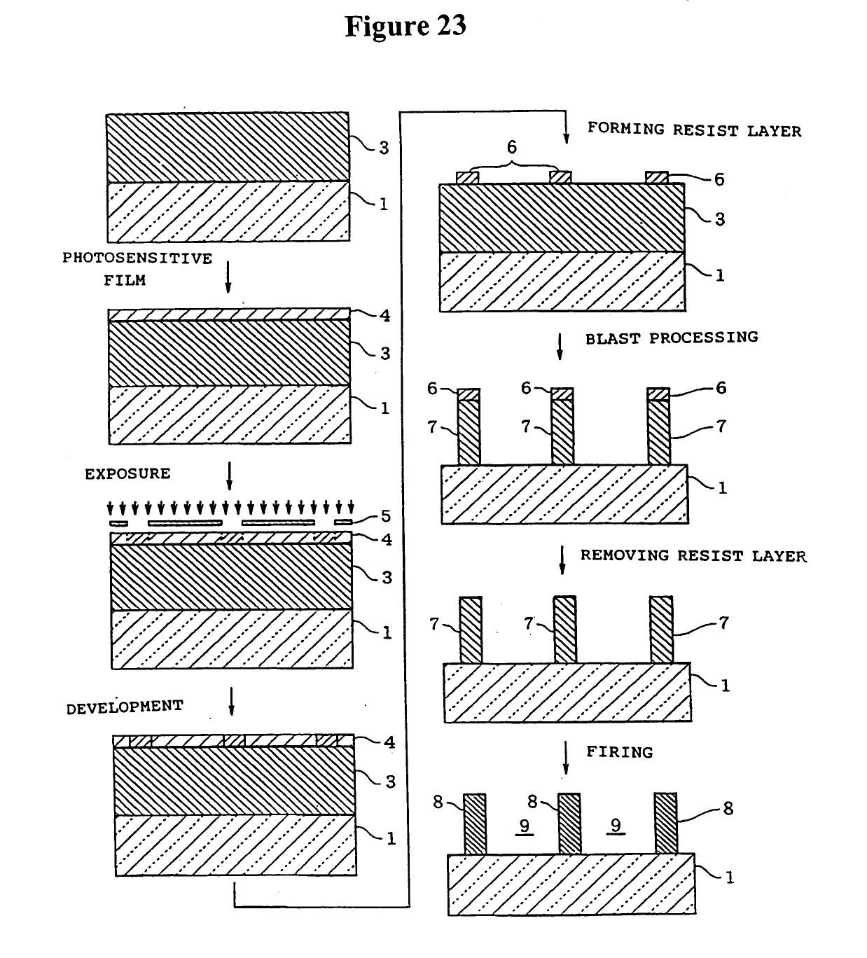

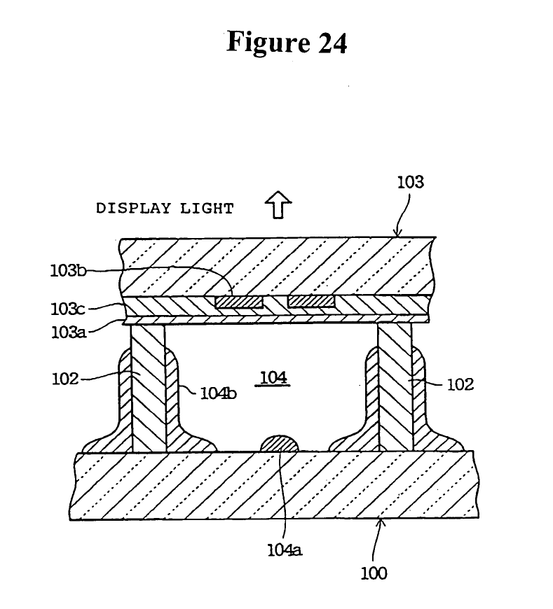

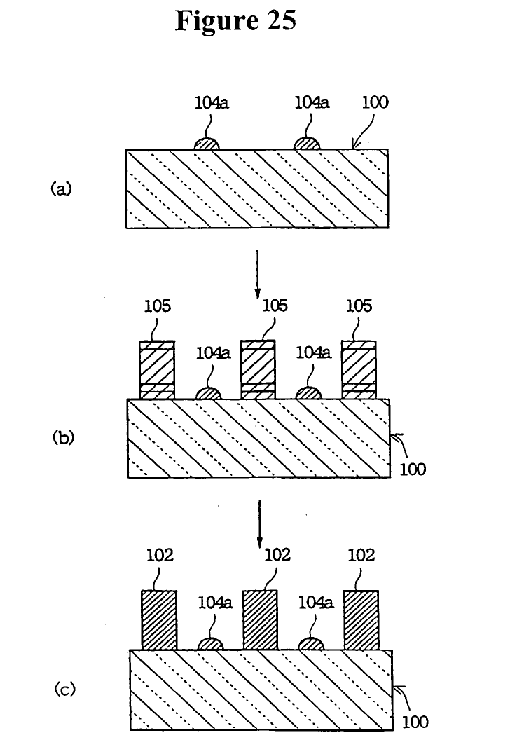

As shown in FIG. 22, a rib forming paste 2 comprising a glass powder, an organic binder and a solvent mixture having a viscosity of 50,000 ps was coated onto a soda-lime glass substrate 1 by the screen printing process by positioning with a prescribed pattern, and dried at 150° C. for ten minutes. The paste was lap-coated by repeating the aforementioned steps twelve times. The lap coating was carried out to achieve a ceramic green rib height H of 200 μm. The rib forming paste contains a glass powder mainly comprising SiO₂, ZnO and PbO and an Al₂O₃ powder. Ethylcellulose was used as a resin, and α-terepineol served as a solvent mixture. Ceramic green ribs 2 were formed at prescribed intervals (cell 9 width S) as a result. Then, ceramic ribs 8 having a height H of about. 170 μm were formed on the substrate 1 by subjecting the structure comprising the substrate 1 having the ceramic green ribs 2 formed thereon to a heat treatment in the open air at 550° C. for an hour.

### Comparison Test and Evaluation

Ceramic ribs 14 and 25 were formed by drying the ceramic capillary ribs 13 and 23 formed on the substrate 10 in Examples 1 to 15 into ceramic green ribs (not shown), further heating the dried ribs for removing the binder, and then firing the same. For 100 ribs arbitrarily selected from the ceramic ribs 14 and 25 resulting from firing and another 100 ribs arbitrarily selected from the ceramic ribs 8 obtained in Comparative Example 1. the height H and the width were measured as follows. The ceramic capillary ribs 13 in Example 1 were dried at 150° C. for 30 minutes to remove the solvent mixture into ceramic green ribs, and after heating at 350° C. for 60 minutes for removing the binder, fired at 560° C. for an hour, thereby obtaining ceramic ribs.

The ceramic capillary ribs 13 in Example 2 were formed by removing the solvent mixture through drying at 150° C. for 30 minutes, heating the dried paste film at 350° C. for 60 minutes for removing the binder, and then firing the game at 580° C. for an hour. The ceramic capillary ribs 13 in Example 3 were formed by removing the solvent mixture through drying at 150° C. for 30 minutes to form ceramic green ribs, heating the same at 350° C. for 60 minutes for removing the binder, and then, firing the same at 550° C. for an hour. The ceramic capillary ribs 13 in Examples 4 to 6 were formed by drying the paste film at the room temperature for ten minutes, then further heating for removing the binder, and firing the same at 550° C. for ten minutes to obtain ceramic ribs and an insulating layer.

In Examples 7 to 9, ceramic capillary ribs 13 formed on the substrate 10 are converted into ceramic green ribs (not shown) by removing the solvent medium through drying in the open air at 150° C. for 20 minutes, and after further heating at 350° C. for 60 minutes for removing the binder, the ceramic green ribs were fired in the open air at 550° C. for ten minutes into ceramic ribs 14.

In Example 10, the ceramic capillary ribs 13 were formed by irradiating ultraviolet rays having a wavelength of 256 nm for one minute, forming ceramic green ribs by drying the same in the open air at 150° C. for 20 minutes to remove the solvent mixture, further heating at 350° C. for 60 minutes for remove the binder, and then firing the same in the open air at 550° C. for 20 minutes.

In Examples 11 to 15, the ceramic capillary ribs 13 formed on the substrate were dried in the open air at 150° C. for 20 minutes to remove the solvent mixture, thereby forming ceramic green ribs (not shown). The thus formed ceramic green ribs were further heated at 350° C. for 60 minutes, and then fired in the open air at 550° C. for ten minutes, thus obtaining ceramic ribs 14.

For 100 ribs arbitrarily selected from the ceramic ribs 14 and 25 in Examples 1 to 15 obtained by firing as described above, and 100 ribs arbitrarily selected from the ceramic ribs 8 obtained in Comparative Example 1, the height H and the width were measured as follows.

As shown in FIG. 2, measurement of width of the arbitrary 100 ceramic ribs on the substrates in Examples 1 to 15 and Comparative Example 1 was carried out by measuring the rib width Wc at a height (½)H, H being the ceramic ribs height, the rib width W_{M} at a height (¾)H, and the rib width W_{T} at a height (9/10)H.

After calculating average values of these measured values, dispersions as expressed by (Maximum or Minimum-Average)/(Average) of H, W_{c}, W_{M} and W_{T}, respectively, were calculated. Table 1 compares the results for Examples 1 to 3 and that for Comparative Example 1. Table 2 compares the results for Examples 4 to 6 and that for Comparative Example 1. Table 3 compares the results for Examples 7 and 8, and Table 4 compares the results for Examples 9 and 10, respectively, with that for Comparative Example 1. Table 5 compares the results for Examples 11 to 13, and Table 6 compares the results for Examples 14 and 15, respectively, with that for Comparative Example 1.

TABLE 1

| | | | | Comparative |
|---|---|---|---|---|
| | Example 1 | Example 2 | Example 3 | Example 1 |
| H (100) (μm) | 200˜202 | 148˜151 | 249˜251 | 161˜182 |
| W_{T} (100) (μm) | 20˜21 | 35˜36 | 15˜16 | 38˜44 |
| W_{M} (100) (μm) | 25˜26 | 42˜44 | 20˜21 | 41˜48 |
| W_{c} (100) (μm) | 30˜32 | 50˜52 | 25˜26 | 49˜56 |
| H (average) (μm) | 201.01 | 149.73 | 249.96 | 171.52 |
| W_{T} (average) (μm) | 20.51 | 35.52 | 15.51 | 41.03 |
| W_{M} (average) (μm) | 25.49 | 43.00 | 20.49 | 44.47 |
| W_{c} (average) (μm) | 31.02 | 50.98 | 25.50 | 52.54 |
| Dispersion of H (%) | +0.5/−0.5 | +0.8/−1.2 | +4.2/−3.8 | +6.1/−6.1 |
| Dispersion of W_{T} (%) | +2.4/−2.5 | +1.4/−1.5 | +3.2/−3.3 | +7.2/−7.4 |
| Dispersion of W_{M} (%) | +2.0/−1.9 | +2.3/−2.3 | +2.5/−2.4 | +7.9/−7.8 |
| Dispersion of W_{c} (%) | +3.2/−3.3 | +2.0/−1.9 | +2.0/−2.0 | +6.5/−6.7 |

TABLE 2

| | | | | Comparative |
|---|---|---|---|---|
| | Example 4 | Example 5 | Example 6 | Example 1 |
| H (100) (μm) | 118˜121 | 119˜120 | 124˜120 | 161˜182 |
| W_{T} (100) (μm) | 10˜11 | 8 | 15˜16 | 38˜44 |
| W_{M} (100) (μm) | 20˜22 | 17˜18 | 24˜26 | 41˜48 |
| W_{c} (100) (μm) | 45˜47 | 30˜32 | 48˜50 | 49˜56 |
| H (average) (μm) | 119.01 | 119.86 | 124.55 | 171.52 |
| W_{T} (average) (μm) | 10.47 | 8.0 | 15.56 | 41.03 |
| W_{M} (average) (μm) | 21.20 | 17.49 | 25.03 | 44.47 |
| W_{c} (average) (μm) | 46.02 | 31.08 | 49.36 | 52.54 |
| Dispersion of H (%) | +1.7/−0.8 | +0.1/−0.7 | +0.4/−0.4 | +6.1/−6.1 |
| Dispersion of W_{T} (%) | +5.1/−5.1 | +0/−0 | +2.8/−3.6 | +7.2/−7.4 |
| Dispersion of W_{M} (%) | +3.8/−5.7 | +2.9/−2.8 | +3.9/−4.1 | +7.9/−7.8 |
| Dispersion of W_{c} (%) | +2.1/−2.1 | +3.0/−2.8 | +1.3/−2.8 | +6.5/−6.7 |

As in clear from tables 1 and 2. the results for Examples 1 to 6 suggest that the method of the present invention permits effective formation of ceramic capillary ribs on a substrate. It is clear that ceramic ribs are available by drying the ceramic capillary ribs further heating them for removing the binder, and then firing them, and that it is possible to easily obtain ceramic ribs without waste of materials wit ha fewer steps as compared with Comparative Example 1. Further, because the ceramic ribs obtained by drying, heating and firing the ceramic capillary ribs have an aspect ratio of from 2 to 10, the present invention can give very accurate ceramic ribs.

TABLE 3

| | | | Comparative |
|---|---|---|---|
| | Example 7 | Example 8 | Example 1 |
| H (100) (μm) | 349˜355 | 412˜421 | 161˜182 |
| W_{T} (100) (μm) | 56˜60 | 43˜47 | 38˜44 |
| W_{M} (100) (μm) | 62˜67 | 52˜56 | 41˜48 |
| W_{c} (100) (μm) | 71˜76 | 61˜65 | 49˜56 |
| H (average) (μm) | 352.21 | 416.53 | 171.52 |
| WT (average) (μm) | 57.96 | 44.93 | 41.03 |
| W_{M} (average) (μm) | 64.53 | 54.06 | 44.47 |
| W_{c} (average) (μm) | 73.57 | 62.87 | 52.54 |
| Dispersion of H (%) | +0.8/−0.9 | +1.1/−1.1 | +6.1/−6.1 |
| Dispersion of W_{T} (%) | +3.5/−3.4 | +4.6/−4.3 | +7.2/−7.4 |
| Dispersion of W_{M} (%) | +3.8/−3.9 | +3.6/−3.8 | +7.9/−7.8 |
| Dispersion of W_{c} (%) | +3.3/−3.5 | +3.4/−3.0 | +6.5/−6.7 |

TABLE 4

| | | | Comparative |
|---|---|---|---|
| | Example 9 | Example 10 | Example 1 |
| H (100) (μm) | 322 ˜ 327 | 306 ˜ 312 | 161 ˜ 182 |
| W_{T} (100) (μm) | 49 ˜ 53 | 58 ˜ 62 | 38 ˜ 44 |
| W_{M} (100) (μm) | 55 ˜ 58 | 64 ˜ 70 | 41 ˜ 48 |
| W_{c} (100) (μm) | 67 ˜ 72 | 77 ˜ 83 | 49 ˜ 56 |
| H (average) (μm) | 324.40 | 308.94 | 171.52 |
| W_{T} (average) (μm) | 51.22 | 60.01 | 41.03 |
| W_{M} (average) (μm) | 56.47 | 66.93 | 44.47 |
| W_{c} (average) (μm) | 69.41 | 80.05 | 52.54 |
| Dispersion of H (%) | +0.8/−0.7 | +1.0/−1.0 | +6.1/−6.1 |
| Dispersion of W_{T} (%) | +3.5/−4.3 | +3.3/−3.3 | +7.2/−7.4 |
| Dispersion of W_{M} (%) | +2.7/−2.6 | +4.6/−4.4 | +7.9/−7.8 |
| Dispersion of W_{c} (%) | +3.7/−3.5 | +3.7/−3.8 | +6.5/−6.7 |

TABLE 5

| | Example | Example | Example | Comparative |
|---|---|---|---|---|
| | 11 | 12 | 13 | Example 1 |
| H (100) (μm) | 162˜166 | 179˜182 | 195˜198 | 161˜182 |
| W_{T} (100) (μm) | 73˜76 | 64˜67 | 53˜55 | 38˜44 |
| W_{M} (100) (μm) | 86˜89 | 70˜73 | 62˜64 | 41˜48 |
| W_{c} (100) (μm) | 94˜97 | 80˜83 | 77˜80 | 49˜56 |
| H (average) (μm) | 164.12 | 180.45 | 196.39 | 171.52 |
| W_{T} (average) (μm) | 74.47 | 65.50 | 54.22 | 41.03 |
| W_{M} (average) (μm) | 87.63 | 71.47 | 62.97 | 44.47 |
| W_{c} (average) (μm) | 95.47 | 81.46 | 78.44 | 52.54 |
| Dispersion of H (%) | +1.1/−1.3 | +0.9/−0.8 | +1.6/−0.7 | +6.1/−6.1 |
| Dispersion of W_{T} (%) | +2.1/−2.0 | +2.3/−2.3 | +1.4/−2.3 | +7.2/−7.4 |
| Dispersion of W_{M} (%) | +1.6/−1.9 | +2.1/−2.1 | +1.6/−1.5 | +7.9/−7.8 |
| Dispersion of W_{c} (%) | +1.6/−1.5 | +1.9/−1.8 | +2.0/−2.0 | +6.5/−6.7 |

TABLE 6

| | | | Comparative |
|---|---|---|---|
| | Example 14 | Example 15 | Example 1 |
| H (100) (μm) | 151˜153 | 181˜184 | 161˜182 |
| W_{T} (100) (μm) | 71˜73 | 51˜53 | 38˜44 |
| W_{M} (100) (μm) | 84˜87 | 63˜65 | 41˜48 |
| W_{c} (100) (μm) | 92˜94 | 78˜81 | 49˜56 |
| H (average) (μm) | 152.22 | 182.59 | 171.52 |
| W_{T} (average) (μm) | 72.12 | 51.89 | 41.03 |
| W_{M} (average) (μm) | 85.46 | 64.06 | 44.47 |
| W_{c} (average) (μm) | 93.02 | 79.55 | 52.54 |
| Dispersion of H (%) | +0.5/−0.8 | +0.8/−0.9 | +6.1/−6.1 |
| Dispersion of W_{T} (%) | +1.2/−1.6 | +2.1/−1.7 | +7.2/−7.4 |
| Dispersion of W_{M} (%) | +1.8/−1.7 | +1.5/−1.7 | +7.9/−7.8 |
| Dispersion of W_{c} (%) | +1.1/−1.1 | +1.8/−1.9 | +6.5/−6.7 |

As is evident from Tables 3 and 4, the results for Examples 7 to 10 suggest that the use of the paste of the present invention permits effective formation of ceramic capillary ribs on a substrate. In Examples 7 to 10, ceramic ribs can be obtained by drying, further heating to remove the binder, and then firing the ceramic capillary ribs. In Example 10, ceramic ribs are available by forming ceramic capillary ribs in an atmosphere shielded from ultraviolet rays, irradiating ultraviolet rays for a prescribed period of time, drying and firing the same. It is possible to easily obtain ceramic ribs without waste of materials with a fewer steps as compared with Comparative Example 1. Further, because the ceramic ribs obtained by drying, heating and firing, or irradiating ultraviolet rays to, drying and firing the ceramic capillary ribs have an aspect ratio of from 2 to 10, the present invention can give very accurate ceramic ribs.

As is clear from Table 5, in Examples 11 to 13, as compared with Comparative Example 1, the paste film has an appropriate hardness under the effect of defoaming and self-setting, thermosetting of photosetting after formation of the paste film, and ceramic ribs with slight dispersions in height and width can be formed on the substrate.

As is clear from Table 6, as compared with Comparative Example 1, in Examples 14 and 15. the three solvents sequentially volatilize during drying after formation of the ceramic capillary ribs. The capillary ribs therefore never get out of shape, and ceramic green ribs retain the original shape, thus making it possible to form ceramic ribs with slight dispersions in height and width from the green ribs on the substrate.

### Example 16

A plurality of Ag pastes were coated in rows by the screen printing process on a rectangular soda-lime glass substrate having a diagonal size of 40 inches and a thickness of 3 mm. After drying in the open air atmosphere at 150° C. for ten minutes, an address electrode having a width of 50 μm and a height of 15 μm was formed by firing at 570° C. for ten minutes.

On the other hand, 70 wt. % PbO—SiO₂—B₂O₃ glass powder having an average particle size of 3 μm and 30 wt. % alumina powder having an average particle size of 5 μm serving as a filler were prepared and sufficiently mixed. The resultant mixed powder, ethylcellulose serving as a resin, and a solvent mixture were blended at a weight ratio of 80/2/18, and sufficiently kneaded to obtain a ceramic paste. The solvent mixture is a mixture of α-terepineol serving as a solvent, glycerine serving as a plasticizer, and sulfonic acid serving as a dispersant. As shown in FIG. 21, a paste film 11 was formed by coating the thus obtained ceramic paste onto the glass substrate having the address electrode formed thereon by the screen printing process into a thickness of 200 μm.

On the other hand, a blade 12 was prepared from a stainless steel sheet having a thickness of 0.1 mm, with comb-teeth 12b shown in FIG. 4, a pitch P of 100 μm, a gap depth h of comb-teeth 12b of 300 μm, and a width w of 40 μm. The substrate 10 was fixed in a state in which the comb-teeth 12b of the blade 12 was thrust into the paste film, and the edge 12a is brought into contact with the upper surface of the address electrode 11a, and ceramic capillary ribs 23 having a width of 45 μm at the rib bottom and a height of 160 μm and a ceramic capillary layer 22 having a thickness of 15 μm were simultaneously formed on the substrate 10 surface by moving the blade 12 in a certain direction.

Ceramic green ribs and a ceramic green layer (not shown) were formed by drying the ceramic capillary ribs 23 and the ceramic capillary layer 22 formed on the substrate 10. The binder was removed by heating, and there were integrally formed ceramic ribs 25 having a rib bottom width of 35 μm and a height of 130 μm and an insulating layer 24 having a thickness of 12 μm by firing (FIG. 20). Because the insulating layer 24 served as a base layer, the ceramic ribs 25 were very firmly provided on the substrate 10.

Obviously, numerous modifications and variations of the present invention are possible in light of the above teachings. It is therefore to be understood that within the scope of the appended claims, the invention may be practiced otherwise than as specifically described herein.

What is claimed is:

1. A method of forming ceramic capillary ribs, comprising the steps of:
forming a ceramic paste film by coating a ceramic paste on [the] a surface of a substrate; and
moving one of a blade and said substrate in a predetermined direction in a state in which comb-teeth formed on at least a part of said blade are thrust into said paste film, thereby forming ceramic capillary ribs on the surface of said substrate.

2. A method of forming ceramic capillary ribs, comprising the steps of:
forming a ceramic paste film by coating a ceramic paste on a surface of a substrate; and
moving one of a blade and said substrate in a predetermined direction in a state in which comb-teeth formed on at least a part of said blade are thrust into said paste film, thereby forming a ceramic capillary layer on the surface of said substrate and ceramic capillary ribs on said ceramic capillary layer.

3. A ceramic paste used for a method of forming ceramic capillary ribs according to claims 1 or 2, wherein the step of forming the paste comprises forming a paste containing a glass powder or glass/ceramic mixed powder in an amount of from 30 to 95 wt. %, a resin in an amount of from 0.3 to 15 wt. %, and a solvent mixture containing a solvent, a plasticizer and a dispersant in an amount of from 3 to 70 wt. %.

4. A ceramic paste according to claim 3, wherein-said resin is comprises one of a thermosetting resin and a photosetting resin.

5. A ceramic paste according to claim 4, wherein said thermosetting resin comprises at least one resin selected from the group consisting of phenol resin, urea resin, melamine resin, alkyd resin, silicone resin, furan resin, unsaturated polyester resin, epoxy resin and polyurethane resin.

6. A ceramic paste according to claim 4, wherein said photosetting resin comprises at least one resin selected from the group consisting of benzophenone resin, dibenzyl ketone resin, diethylthioxanthone resin, anthrone resin, and dibenzosuberone resin.

7. A ceramic paste according to claim 3, wherein said resin comprises one of a self-setting, resin which polymerization-reacts with a solvent and causes with time an increase in paste viscosity, and resin which contains a self-setting resin.

8. A ceramic paste according to claim 7, wherein said resin and said solvent comprises one of a water-soluble epoxy resin containing triethylenetetramine, PVA and formaldehyde, and a water-insoluble epoxy resin containing xylenediamine, respectively.

9. A ceramic paste according to claim 3, wherein said solvent contained in said solvent mixture comprises one of a plurality of kinds of solvent having boiling points which are different from each other by more than 30° C.

10. A ceramic paste according to claim 3, wherein the paste further contains a degassing agent in addition to the solvent, the plasticizer and the dispersant contained in the solvent mixture.

11. An apparatus for forming ceramic capillary ribs, comprising:
a base horizontally supporting the substrate;
a moving head horizontally movably positioned above said base;
a blade holder attached to said moving head;
a blade held by said holder at a position opposite said substrate and at right angles to a direction of moving of said moving head, wherein a lower part of the blade includes comb-teeth held horizontally; and
an actuator causing said moving head to move horizontally;
wherein a ceramic capillary rib is formed on a surface of said substrate by horizontally moving said blade by thrusting said comb-teeth into the ceramic paste film formed on the surface of said substrate.

12. An apparatus for forming ceramic capillary ribs according to claim 11, wherein said blade holder is vertically movably attached to the moving head via holder depressing means which pushes down said blade holder so that the lower ends of the comb-teeth are in contact with the substrate under a predetermined pressure.

13. An apparatus for forming ceramic capillary ribs according to claim 12, wherein a pair of holder depressing means are provided on the moving head at one of a position[s] corresponding to [the both] opposite ends of the blade [or to] and a position[s] [near the both] in proximity with said opposite ends.

14. An apparatus for forming ceramic capillary ribs according to claim 11, wherein:
said blade holder is vertically movably attached to the moving head via blade adjusting means for adjusting the vertical position of the lower ends of the comb-teeth;
said moving head is provided with position sensors for detecting one of a displacement of the substrate surface relative to a reference position of the substrate surface, and a displacement of the ceramic paste film surface relative to a reference position of the ceramic paste film surface; and
wherein a controller is provided for controlling said blade adjusting means by the use of the detection output of said position sensors.

15. An apparatus for forming ceramic capillary ribs according to claim 14, wherein a pair of blade adjusting means are provided on the moving head at positions corresponding to one of opposite ends of the blade and positions in proximity with each of said ends.

16. An apparatus for forming ceramic capillary ribs according to claims 14 or 15 wherein said position sensor detects one of a displacement of the substrate surface and a displacement of the ceramic paste film ahead of the blade in the moving direction.

17. An apparatus for forming ceramic capillary ribs according to claims 14 or 15, wherein said position sensor detects one of a displacement of the substrate surface and a displacement of the ceramic paste film directly below the blade in a longitudinal direction.

18. A ceramic capillary rib formed by the use of the forming apparatus according to claim 11.

19. An apparatus for forming ceramic capillary ribs, comprising:
a base having a carriage horizontally supporting a substrate;
a fixed head positioned above said carriage;
a blade holder attached to said fixed head; and a blade held by said blade holder, opposite to said substrate and at right angles to a moving direction of said carriage, wherein a lower part of the blade includes comb-teeth directed horizontally; and
wherein said carriage is horizontally movable with said comb-teeth thrust into the ceramic paste film formed on the surface of said substrate, thereby forming ceramic capillary ribs on the surface of said substrate.

20. An apparatus for forming ceramic capillary ribs according to claim 19, wherein said blade holder is vertically movably attached to the fixed head via holder depressing means which pushes down said blade holder so that the lower ends of the comb-teeth are in contact with the substrate under a predetermined pressure.

21. An apparatus for forming ceramic capillary ribs according to claim 20, wherein a pair of holder depressing means are provided on the fixed head at positions corresponding to one of opposite ends of the blade and positions in proximity with said ends.

22. An apparatus for forming ceramic capillary ribs according to claim 19, wherein:
said blade holder is vertically movably attached onto the fixed head via blade adjusting means for adjusting a vertical position of lower ends of the comb-teeth;
said fixed head is provided with position sensors for detecting one of a displacement of the substrate surface relative to a reference position of the substrate surface and a displacement of the ceramic paste film surface relative to a reference position of the ceramic paste film surface: and
a controller is provided for controlling said blade adjusting means by the use of the detection output of said position sensors.

23. An apparatus for forming ceramic capillary ribs according to 22, wherein a pair of blade adjusting means are provided on the fixed head at one of positions corresponding to the opposite ends of the blade and positions in proximity with said ends.

24. An apparatus for forming ceramic capillary ribs according to claims 21 or 22 wherein said position sensor detects one of said a displacement of the substrate surface and said displacement of the ceramic paste film ahead of the blade in the moving direction of the blade relative to the carriage serving as a reference.

25. An apparatus for forming ceramic capillary ribs according to claims 22 or 23, wherein said position sensor detects one of said displacement of the substrate surface and said displacement of the ceramic paste film directly below the blade in the longitudinal direction.

26. A ceramic capillary rib formed by to use of the forming apparatus according to claim 19.

27. A blade having comb-teeth formed on an edge thereof, used in the method for forming a ceramic capillary rib according to claims 1 or 2.

28. A blade according to claim 27, wherein said blade has a thickness (t) within a range of from 0.01 to 3.0 mm, and when the comb-teeth have a pitch P, the gap between the comb-teeth is W, and the gap has a depth h, these parameters are in relationship of 0.03 mm≦h≦1.0 mm and W/P≦5−0.9.

29. A blade according to claim 27, wherein the gaps of the comb-teeth comprise one of rectangular shaped gaps, trapezoidally shaped gaps, and inverted trapezoidally shaped gaps.

30. A ceramic rib formed on a substrate, wherein: when the height of said rib is H, the width of the rib at a height of ½ H is W_{c}, the width of the rib at a height of ¾ H is W_{M}, and the width of the rib at a height of 9/10 H is W_{T},
the dispersion of each of H, W_{c}, W_{M} and W_{T} as expressed as (maximum or minimum value−average value)/average value is up to 5%, and the aspect ratio as expressed as H/W_{c} is within a range of from 1.5 to 10.

31. A ceramic rib formed on an insulating layer formed on a substrate, wherein:
when the height of said rib is H, the width of the rib at a height of ½H is W_{c}, the width of the rib at a height of ¾H is W_{M}, and the width of the rib at a height of 9/10H is W_{T},
the dispersion of each of H, W_{c}, W_{M} and W_{T} as expressed as (maximum or minimum value−average value)/average value is up to 5%, and the aspect ratio as expressed as H/W, is within a range of from 1.5 to 10.

32. An FPD having ceramic ribs prepared by firing ceramic capillary ribs formed by the method according to claim 1.

33. An FPD having ceramic ribs formed on an insulating layer prepared by firing a ceramic capillary layer and ceramic capillary ribs formed by the method according to claim 2.

34. A PDP which comprises a plurality of address electrodes formed in a plurality of rows are formed at prescribed intervals on a substrate, and plurality of ceramic ribs formed between said address electrodes in the plurality of rows, wherein:
an insulating layer covering said address electrodes is formed integrally with said ceramic rib on the substrate, and the insulating layer on the upper surface of said address electrodes has a thickness within a range of from 0 to 20 μm.

35. A manufacturing method of PDP, comprising:
forming a plurality of rows of address electrodes at prescribed intervals on a substrate;
forming a ceramic paste film by coating a ceramic paste with a prescribed thickness on the surface of said substrate so as to cover said plurality of rows of address electrodes;
forming a plurality of ceramic capillary ribs between said plurality of rows of address electrodes and forming a ceramic capillary layer covering said address electrodes by moving one of a blade and said substrate in a predetermined direction in a state in which comb-teeth formed along the edge of the blade are thrust into said paste film; and
integrally forming an insulating layer covering said ceramic ribs and said address electrodes on said substrate by drying and then firing said ceramic capillary ribs and said ceramic capillary layer such that the insulating layer on the upper surface of said address electrodes has a thickness within a range of from 0 to 20 μm.

36. An apparatus for forming ceramic capillary ribs according to claim 11, wherein said blade holder is vertically movably attached to the moving head via a holder depressing mechanism which pushes down the blade holder so that the lower ends of the comb-teeth are in contact with a substrate under a predetermined pressure.

37. An apparatus for forming ceramic capillary ribs according to claim 36, wherein a pair of holder depressing mechanisms are provided on the moving head at one of a position corresponding to opposite ends of the blade and a position in proximity with said opposite ends.

38. An apparatus forming ceramic capillary ribs according to claim 11, wherein said blade holder is vertically movably attached to the moving head via a blade adjusting mechanism adjusting the vertical position of the lower ends of the comb-teeth;
said moving head is provided with position sensors detecting one of a displacement of the substrate surface relative to a reference position of the substrate surface and a displacement of the ceramic paste film surface relative to a reference position of the ceramic paste film surface; and
wherein a controller is provided for controlling said blade adjusting mechanism by use of the detection output of said position sensors.

39. An apparatus for forming ceramic capillary ribs according to claim 38, wherein a pair of blade adjusting mechanisms are provided on the moving head at positions corresponding to one of opposite ends of the blade and positions in proximity with each of said ends.

40. An apparatus for forming ceramic capillary ribs according to claims 38 or 39, wherein said position sensor detects one of a displacement of the substrate surface and a displacement of the ceramic paste film ahead of the blade in the moving direction.

41. An apparatus for forming ceramic capillary ribs according to claims 38 or 39, wherein said position sensor detects one of a displacement of the substrate surface and a displacement of the ceramic paste film directly below the blade in a longitudinal direction.

42. An apparatus for forming ceramic capillary ribs according to claim 19, wherein said blade holder is vertically movably attached to the fixed heads via a holder depressing mechanism which pushes down said blade holder so that the lower ends of the comb-teeth are in contact with a substrate under a predetermined pressure.

43. An apparatus for forming ceramic capillary ribs according to claim 42, wherein a pair of holder depressing mechanisms are provided on the fixed head at positions corresponding to one of both ends of the blade and a position in proximity with said ends.

44. An apparatus for forming ceramic capillary ribs according to claim 19, wherein:
said blade holder is vertically movably attached onto the fixed head via a blade adjusting mechanism adjusting a vertical position of lower ends of the comb-teeth;
said fixed head is provided with position sensors detecting one of a displacement of the substrate surface relative to a reference position of the substrate surface and a displacement of the ceramic paste film surface relative to a reference position of the ceramic paste film surface; and
a controller is provided controlling said blade adjusting mechanism by the use of the detection output of said position sensors.

45. An apparatus for forming ceramic capillary ribs according to claim 44, wherein a pair of blade adjusting mechanisms are provided on the fixed head at one of positions corresponding to opposite ends of the blade at positions in proximity with said ends.

46. An apparatus for forming ceramic capillary ribs according to claims 43 or 44, wherein said position sensor detects one of a displacement of the substrate surface and a displacement of the ceramic paste film ahead of the blade in the moving direction of the blade relative to the carriage serving as a reference.

47. An apparatus for forming ceramic capillary ribs according to claims 44 or 45, wherein said position sensor detects one of said displacement of the substrate surface and said displacement of the ceramic paste film directly below the blade in the longitudinal direction.
